(19) United States
(12) Patent Application Publication
(10) Pub. No.: US 2011/0082824 A1
(43) Pub. Date: Apr. 7, 2011

(54) Method for selecting an optimal classification protocol for classifying one or more targets

(76) Inventors: David Allison, Woodland Hills, CA (US); Karmel Allison, Woodland Hills, CA (US); Zach Lyon, Reno, NV (US)

(21) Appl. No.: 12/574,672

(22) Filed: Oct. 6, 2009

(51) Int. Cl. G06Q 10/00; G06F 15/18; G06N 5/02

(52) U.S. Cl. 706/20; 706/12; 706/46; 705/7.11

(57) ABSTRACT

A framework for comparison and optimization of classifiers and features for classification of targets includes preparing training and testing sets, applying a classifier to the training set to achieve a distinctly trained classifier for each classifier applied, applying each resulting trained classifier to the testing data set, selecting an optimal classifier, and applying the optimal classifier to the target. The framework is used to optimally classify a physical representation of a target, such as a document, news article, or advertisement. The framework allows for targeted advertisements to be directed to consumers based on user preferences learned from user activities across a network.

### CROSS REFERENCE TO RELATED APPLICATIONS

Not applicable.

### STATEMENT REGARDING FEDERALLY-SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates generally to a framework for selecting an optimal classification protocol. Specifically, the present invention relates to systems and methods for comparison and optimization of classifiers and features for classifying documents, articles, advertisements, and other physical targets.

Classification is the process of assigning categories or classes to specific targets. Targets may include physical or tangible items containing text, such as documents or articles. In the context of documents, classification has numerous applications ranging from spam identification to unstructured content categorization to evidentiary discovery. There are a substantial number of different classification techniques that may be employed, each of which captures and uses different information about the text being classified. Each of these techniques is suited to a different set of classification tasks, with some techniques being wholly unsuited to certain classes of tasks, and others being particularly useful for just one or two specific tasks.

One application of classification is matching an individual to a target for marketing products and services. This may be performed by observation or information gathering through various media, including mail, electronic mail, the World Wide Web, and telemarketing. Different types of media are suitable for different targeted marketing purposes.

Online information gathering and message targeting offer substantial potential for advances in real-time online targeting of content to an individual user, which can be extended to other media such as mail and, telemarketing, and the like. However, substantial challenges exist in making real-time decisions for targeting online users. Much of the existing art is devoted to discerning predictive attributes or otherwise making profiling-based predictions by statistical analysis of groups sharing certain attributes or characteristics. As will be seen, however, there is a substantial need accurate predictive profiling of user behavior for optimization of classification methods that exceeds generalizations based upon statistical analyses.

Online targeting for marketing purposes is discussed in U.S. Pat. No. 7,424,439 to Usama et al. This reference discloses a method for following a group of users using a learning-based algorithm and a learning set. The method includes a data mining engine capable of being trained with training data and making inferences therefrom as well as from future data. The method provides a user database defining observed characteristics of a set of users, such as user attributes and preferences. The data mining engine is trained with training data comprising the user database. A predetermined characteristic pertaining to the market campaign is input to the engine, such that, in response to the input, a subset of users characterized in the database is selected having a greatest correlation to the characteristic. The outcome is based on the plurality of the individuals in the database without a separate analysis of the individual's profile, and the amount of information used is necessarily limited by only being observed characteristics rather than including affirmative information supplied by users.

U.S. Pat. No. 7,424,439 to Fayyad et al. discloses methods for rapidly distilling and aggregating survey data for predicting statistically normative behavior of a plurality of users of, for example, an individual content site. The utility of the information requires that generalizations be made upon specific behavior common to the group, such as use of a site with specific content. Thus the focus is on a limited profile data set and a statistical normalization of the individual user data into the collective profile of a plurality or group of user's exhibiting a behavior or supplying information.

In U.S. Pat. No. 7,162,522 to Adar et al., demographic information of a web user is predicted based on an analysis of accessed web pages. Web pages accessed by the internet user are detected and mapped to a user path vector converted to a normalized weighted user path vector. A centroid vector identifies web page access patterns of users with a shared user profile attribute assigned to the user based on a comparison of the vectors. Bias values are also assigned to a set of web pages, and a user profile attribute can be predicted for an individual user based on the bias values of accessed sites. User attributes can also be predicted based on the results of an expectation maximization process, and demographic information can be predicted based on the combined results of a vector comparison, bias determination, or expectation maximization process. However, an individual deviating from the centroid vector, for which the bias values are inaccurate or not fitting within the normative expectations used for the expectation maximization process, may be substantially mischaracterized as an artifact of the generalizing nature of the analysis by which the attributes are assigned.

In U.S. Pat. No. 7,370,042 to Grondalski, video is targeted based upon derivation of characteristics or descriptors as parameters of a predictive model from analysis of a group of users. The descriptors are used in the individual user's profile because the group normalized descriptors are used as the basis of individual profiling attributes that a user can use to characterize or define a profile upon the analytically obtained descriptors. An individual chooses a descriptor, but the use of the specific descriptor and the interpretation thereof is based upon normalized analysis. An outlying individual might attribute different meaning to the descriptor and inaccurately self-profile.

U.S. Pat. No. 6,134,532 to Lazarus et al. is directed to a system and method for selecting and presenting personally targeted entities having information content, such as marketing material. The method is based on tracking observed behavior on an individual basis and utilizing a vector space representation for both target information and individual behavior. The system matches users to entities in a manner that improves with increased operation and observation of user behavior. User behavior and entity information are represented as content vectors in a unified adaptive vector space. The system represents information as content vectors, representing both users and entities, and utilizes a constrained self organization learning technique to learn relationships between symbols, for example words in unstructured text. Users and entities are each represented as content vectors. Only observed behavior is used as a basis for prediction. Contextual and other information relating to the user, including information affirmatively supplied as in preference information supplied to a content site or individualized questionnaire response data, are not used. Users willing to submit to questionnaires are difficult to track across multiple content-providing web sites unless the users also accept placement of a cookie. Thus, the predictions made by the method of Lazarus are based upon observed behavior only, and the analysis of Lazarus is necessarily constrained to matching behavior to a target rather than predicting behavior from a more comprehensive data.

Classification techniques, or classifiers, are also well-known to those of ordinary skill in the art. A classifier is considered useful to the extent that it correctly classifies novel material and avoids errors by not assigning an incorrect class to an object or by omitting a class that should be present. Classifiers differ greatly in performance depending on the task they are used to complete, and there are many noteworthy classification techniques. Several common existing classification techniques are the perceptron, decision tree, and multinomial naïve Bayes models. Automated assistance in selecting an appropriate classifier, whether currently known or yet to be developed, for a given classification task is evident in several areas, notably in industry and in research.

The teachings of the prior art show that there is a need for more effective data mining for targeting various items to particular users. One way of improving the effectiveness of data mining is by increasing both the breadth and volume of data used in profiling an individual, and increasing the analytic depth of the individualized analysis. Furthermore, there is a need to create more expansive individual profile data sets to permit a greater depth of individual analysis. Because data sets must be expanded to obtain comprehensive profiles amenable to more in-depth analyses, there is a further need for improvement in effective data collection methods, such as a cookieless ability to both observe and obtain data across multiple content sites, and user-friendly questionnaires or other user-behavior data-gathering for improved individual user profiling. Finally, there is a need for efficient computational methods and system configurations capable of obtaining an intensive individualized analysis for a substantial and rapidly increasing number of individuals.

One of skill in the art will understand that the following invention overcomes the limitations of the prior art because classifier technology must constantly change to keep up with the ever-increasing accumulation and speed of data in a connected world. It is highly beneficial to measure new and old classification techniques before deploying them to ensure effectiveness in classifying one or more targets. Because much of the existing art is devoted to discerning predictive attributes or otherwise making predictions by statistical analysis based on profiles of groups sharing certain attributes or characteristics, there is a need for a framework for more accurate analysis to account for increasing, dynamically-generated data and a demand for more accurate classification of targets. It would not be obvious for one of skill in the art to arrive at the invention described herein because the invention contemplates a system and method of optimally classifying one or more classifiers regardless of the set of classifiers used and regardless of whether the set of classifiers is now known or understood to be effective in solving a particular classification problem. Additionally, the invention described herein solves the problems described above and is scalable to incorporate user characteristics derived from user behavior across a network and for multiple users to effectively classify one or more targets for applications appropriate for their physical implementation.

### BRIEF SUMMARY OF THE INVENTION

The present invention is directed to methods and corresponding systems for associating online user survey and behavior data, and generating predicted behavior derived from the user data, with one or more targets. A profile data set of an identified user is expanded by collection of identifiers comprising a unique anonymous identity profile permitting tracking of an individual user across multiple content sites and when accessing the web from multiple computers and locations. Efficient combinatorial generation of target attributes from template targets economizes resources, including processing. Processing functions are separated to take advantage of distributed computing with parallel processing and scalability, required to amass and effectively utilize large amounts of data per user with a large number of users, and still deliver effective target matches in real time.

The present invention is also directed to methods and corresponding systems for associating a user comprehensive profile or a user predicted behavior profile derived by analysis of the user comprehensive profile with one or more targets. In several embodiments, the methods and corresponding systems of the present invention track a uniquely identified anonymous user across multiple content sites or platforms and logging onto the system from multiple computers to obtain a robust and historically complete user comprehensive profile by the assembly of a user unique anonymous identity profile comprising a collection of quasi-unique, semi-unique, and group identifiers which together allow a probabilistically sufficiently unique association with an unnamed individual. These embodiments also incorporate combinatorial and stepped combinatorial generation of target profiles allowing fewer comparisons and division of processing tasks for streamlined computation.

In one embodiment, the present invention is directed to a method for associating, for one or more users, user survey and user behavior data with one or more targets. The method comprises creating a user comprehensive profile for comparison with target profiles. Survey data from a user is collected and assembled into a collection of digital data values representing a user survey profile. Observed behavior data of an individual user is collected and assembled into a collection of digital data values representing a user behavior profile. A collection of digital data values representing a user comprehensive profile is modified with the user survey profile and the user behavior profile. The user comprehensive profile or a profile derived from the user comprehensive profile is compared to a plurality of target profiles. Data values from the comprehensive profile may be simply selected or computational analysis of the user comprehensive profile is performed to generate a user predicted behavior profile. The target profiles are informative of the targets permitting identification of at least one target profile consistent, or parametrically close, with the comprehensive profile.

The present invention also provides a method for associating, for one or more users, user survey and user behavior data from a uniquely identified user across multiple content sites in a computer network for the purpose of associating the so uniquely identified user with one or more targets. The method comprises collecting a plurality of identifiers pertaining to a user accessing a plurality of different sites, an identifier comprising a collection of digital data values, whereby the collection of identifiers represents a user unique anonymous identity profile, which is maintained and updated for each particular user identified. The collected identifiers may be quasi-unique, semi-unique, and group identifiers that together uniquely yet anonymously identify a particular individual user to a sufficient level of probabilistic certainty for the targeting purpose. Thus the user unique anonymous identity profile identifies an individual user substantially uniquely, and enables following an individual across a plurality of sites, permitting the user survey profile and the user behavior profile to be collected from the plurality of sites. A user having an associated user unique anonymous identity profile logging onto a computer connected to a computer network and engaging in one or more activities can be associated with the unique identity profile by observation of the one or more activities on the computer network.

In these embodiments for matching a target with a profiled user, the data set for profiling is expanded by both combining observed behavior data with affirmatively, actively submitted survey data and expanding the scope of data collection by following an individual user across multiple content sites without placement of a cookie, e.g., cookie-less network-wide persistence. This network-wide persistence is obtained without cookie placement in the user computer by accumulating a collection of quasi-unique, semi-unique and group identifiers comprising a unique anonymous identity profile.

In another embodiment, the invention comprises a computational method for associating, with one or more users, the user survey and user behavior data from a uniquely identified user across multiple content sites in a computer network and for associating the uniquely identified user with one or more targets. The method comprises collecting a plurality of identifiers pertaining to a user accessing a plurality of different sites, and an identifier comprising a collection of digital data values, whereby the collection of identifiers represents a collection of digital data values comprising a user unique anonymous identity profile.

Survey data is collected from a user and assembled into a collection of digital data values representing a user survey profile; observed behavior data of a user is collected and assembled into a collection of digital data values representing a user behavior profile. A collection of digital data values representing a user comprehensive profile is modified with the user survey and behavior profile data. The user comprehensive profile is computationally analyzed by an algorithm to generate a user predicted behavior profile. The user predicted behavior profile or a profile derived from the user predicted behavior profile is compared to a plurality of target profiles, informative of the targets, to identify at least one target profile consistent with or matching the comprehensive profile.

The unique anonymous identity profile identifies an individual user substantially uniquely across a plurality of sites, permitting the survey and behavior profile data to be collected from the various sites. A user having an associated unique anonymous identity profile logging onto a computer connected to a computer network and engaging in one or more activities can be associated with the unique identity profile by observation of the one or more activities on the computer network.

In another embodiment the present invention comprises a method for associating a uniquely identified user with one or more targets, wherein the target profile comprises a defined target profile obtained by a combinatorial generation. A defined target profile is generated from a template target comprising one or more variable elements. Each variable element has at least one selectable attribute, each selectable attribute having properties that may be selected. An individual attribute property is selected from an attribute properties list, which corresponds to an individual selectable attribute. The attribute properties list comprises a plurality of entries, each of the plurality of entries specifying a property that may be selected for the individual selectable attribute to which the attribute properties list corresponds. Making the selection from the attribute properties list for each selectable attribute of each variable elements of the template target generates a defined target profile. The initial comparison of the user comprehensive profile or a profile derived therefrom with the target profiles may utilize at least one target profile comprising a defined target profile to identify at least one target profile consistent with the user comprehensive profile. Alternatively the comparing may initially be of the user comprehensive profile or a profile derived therefrom with target profiles, at least one of the target profiles comprising a template target whereby at least one matching template target consistent with the comprehensive profile is identified. The at least one matching template target is utilized in generating a plurality of defined target profiles. After generating the defined target profile the user comprehensive profile or a user profile derived therefrom to the plurality of fully defined targets.

The method further comprises archiving user profiles wherein user profiles of at least one user are archived at a time interval and a set of archival profiles exists comprising a most recent profile and at least a next most recent profile preceding the most recent profile by the time interval. Preferably the set of archival profiles has an oldest archival profile dating back to an earliest profile associated with the user. Archiving allows change analysis in any user profile over time, which may be performed by utilizing the set of archival profiles. Earlier profiles may precede a next most recent profile in the set of archival profiles by a first time interval or one or more additional time intervals. User profiles comprising a set of archival profiles are selected from the group consisting of user survey profile, user behavior profile, user comprehensive profile, user predicted behavior profile and user unique anonymous identity profile.

In embodiments employing an algorithm to generate a user predicted behavior profile, the generation may be at least in part by selecting pertinent digital data values from the user comprehensive profile. The user comprehensive profile may be organized into sub-profiles, and the selecting pertinent digital data values from the user comprehensive file is at least in part by selecting a sub-profile, which sub-profiles are preferably relationally organized. The predictive algorithm may additionally generate new digital data values for the user predicted behavior profile, which new digital data values may supplement the user comprehensive profile. The predictive algorithm is preferably heuristic. And in embodiments employing a heuristic predictive algorithm and archiving of profiles, the change analysis of archived user profiles may inform the heuristic algorithm.

The present invention also includes a computerized system for associating survey data and behavior data with one or more targets. The system comprises practical processing functions, the system comprising: (i) a survey collector capable of collecting survey data from a user and assembling the survey data into a collection of digital data values representing a user survey profile; (ii) a behavior collector capable of collecting observed behavior data from a user and assembling the observed behavior data into a collection of digital data values representing a user behavior profile; (iii) a profile modifier capable of modifying a collection of digital data values representing a user comprehensive profile with the user survey profile and the user behavior profile; and (iv) a profile comparison analyzer capable of comparing the comprehensive user profile or a profile derived from the user comprehensive profile to a plurality of target profiles, the target profiles informative of the targets. At least one target profile consistent with the comprehensive profile may be identified as matching or parametrically close to the comprehensive profile or profile derived therefrom. The plurality of target profiles may, for example be ranked according to parametric proximity to the comprehensive profile, and at least one target profile is thereby identified as a match, for example as closest or falling within a specified distance of the target in n-dimensional space.

The present invention also includes a computerized system for associating a user predicted behavior profile with one or more targets. The system comprises practical processing functions. The system comprises: (i) a survey collector practical processing function capable of collecting survey data from a user and assembling the survey data into a collection of digital data values representing a user survey profile; (ii) a behavior collector capable of collecting observed behavior data from a user and assembling the observed behavior data into a collection of digital data values representing a user behavior profile; (iii) a profile modifier capable of modifying a collection of digital data values representing a user comprehensive profile with the user survey profile and the user behavior profile; (iv) a predictive analyzer capable of analyzing the user comprehensive profile or a profile derived from the user comprehensive profile according to and wherein user profiles of at least one user are archived at a first time interval.

Typically the computerized systems of the invention further comprise a database comprising a mass storage device controlled by a database manager to serve as a repository of data including user comprehensive and user unique anonymous identity profiles. The database preferably comprises a relational database, more preferably an object relational database. The database permits user profile archiving according to preferred embodiments of the invention. User profiles are archived at a given time interval. A set of archival profiles exists comprising a most recent profile and at least a next most recent profile preceding the most recent profile by the first time interval.

The computerized systems of the invention further comprise a target profile combinator processing function, wherein the target profile combinator generates a template based array comprising at least one possible defined target profile from a specific template target. And for advantageous expansion of the data set pertaining to a particular individual by obtaining cookie-less network wide persistence, the systems of the invention preferably incorporate an identifier collector practical processing function capable of collecting a plurality of identifiers pertaining to a user accessing a plurality of different sites, an identifier comprising a collection of digital data values, whereby the collection of identifiers represents a user unique anonymous identity profile, which identifies an individual user substantially uniquely across a plurality of sites. A user having an associated user unique anonymous identity profile logging onto a computer connected to a computer network can be associated with the user unique anonymous identity profile by observation of the one or more activities on the computer network.

According to some embodiments of the method, the invention is a computational method wherein computationally analyzing the user comprehensive profile comprises an iterative analysis employing an array of a plurality of classifier functions. Each of the plurality of classifier functions has an associated classifier function coefficient and comprises a plurality of decision nodes. Each decision node has an associated decision tolerance parameter, whereby the plurality of associated feature coefficients collectively comprise a classifier feature weighting set. The plurality of associated decision tolerance weighting sets comprises a classifier associated array of decision tolerance weighting sets. The classifier weighting set and the classifier associated array of decision tolerance weighting sets collectively comprise a weighting coefficient matrix.

In each iteration, a predicted behavior profile is generated, using the weighting coefficient matrix, and compared to a post-prediction observed behavior profile collected subsequent to generating the predicted behavior profile. The comparison informs adjustment of the weighting coefficient matrix to generate an adjusted weighting coefficient matrix comprising adjusted classifier function weighting coefficients and adjusted decision tolerance parameters. A predicted behavior profile is generated using the adjusted weighting coefficient matrix in a subsequent iteration. Following an individual user over a series of iterations allows evolution of an individually optimized weighting coefficient matrix as individual users personalized preferences are learned.

In some embodiments the classifier weighting set may be separately analyzed using a representative subset of the decision tolerance weighting sets from the classifier associated array of decision tolerance weighting sets. Following this separate analysis, only classifier functions having a sufficiently high adjusted weighting coefficient are analyzed using the complete classifier associated array of decision tolerance weighting sets.

In one embodiment of the present invention, a method of determining an optimal classifier for classifying a target comprises preparing a training data set from a data source and a testing data set from the data source, the data source indicative of one or more features representative of a physical implementation of a target for classification, the training data set comprising a first logical data grouping from the data source and the testing data set comprising a second logical data grouping from the data source not included in the training data set. The method also includes applying a classifier from a set of classifiers to the training data set to achieve a resulting distinctly trained classifier for each classifier applied, the set of classifiers including at least one classifier appropriate for the classification of the target selected based on the one or more features. The method further includes incrementing a size of the training data set while keeping the testing data set at a fixed size and iteratively reapplying the set of classifiers to produce a resulting distinctly trained classifier for each classifier applied to a different training set size, and applying each resulting trained classifier for each classifier to the testing data set and comparing a result from the application of each resulting trained classifier for each classifier to the training data set to the application of each resulting trained classifier for each classifier to the testing data set. The method also includes selecting an optimal classifier and applying the optimal classifier to the target to classify the physical implementation of the target.

In another embodiment of the present invention, method of selecting an optimal classifier type for a target in a given classification problem, comprises selecting a target from a set of targets, each target in the set of targets representative of a physical article to be classified and being representative of a feature profile identifying one or more features relevant to a classification of each target in the set of targets, selecting one or more classifiers for application to a selected target, comparing, for each of the one or more classifiers, the feature profile of a selected target to a comprehensive user data profile, the comprehensive user data profile including a user's expressed preference and a user's behavioral history, comparing a result for each of the one or more classifiers to a predicted user data profile, and selecting a most appropriate classifier for the one or more classifiers.

Yet another embodiment of the present invention includes a system for associating predicted behavior with one or more targets, comprising a plurality of modules embodied on one or more components in a computer hardware environment, the plurality of modules including a survey collection module configured to collect survey data from a user and assemble the survey data into a collection of digital data values representing a user survey profile, a behavior collection module capable of collecting observed behavior data from a user and assembling the observed behavior data into a collection of digital data values representing a user behavior profile, a profile modifier module capable of modifying a collection of digital data values representing a user comprehensive profile with the user survey profile and the user behavior profile, a predictive analyzer module capable of analyzing the user comprehensive profile or a profile derived from the user comprehensive profile to generate a user predicted behavior profile comprising a collection of digital data values, and a profile comparison analyzer module capable of comparing the user predicted behavior profile to a plurality of target profiles informative of the targets to identify at least one target profile consistent with the user predicted behavior profile.

Still another embodiment of the present invention includes a method for associating a uniquely identified user with one or more targets across multiple content sites, comprising collecting a plurality of identifiers each comprising a collection of digital data values and pertaining to a user accessing a plurality of different sites on a computer network, the plurality of identifiers representing a user unique anonymous identity profile, collecting survey data from the user and assembling the survey data into a collection of digital data values representing a user survey profile, collecting observed behavior data of the user and assembling the observed behavior data into a collection of digital data values representing a user behavior profile, modifying a collection of digital data values representing a user comprehensive profile with the user survey profile and the user behavior profile, and comparing the user predicted behavior profile to a plurality of target profiles informative of the one or more targets to identify at least one target profile consistent with the user predicted behavior profile, wherein the user unique anonymous identity profile identifies an individual user substantially uniquely across the plurality of sites, permitting the user survey profile and the user behavior profile to be collected from the plurality of sites when the user having an associated user unique anonymous identity profile accesses the computer network and engages in one or more activities associated with the associated user unique anonymous identity profile.

Another embodiment of the present invention includes an article of manufacture including a computer usable medium having a computer readable program code embodied therein, the computer readable program code adapted to be executed to implement a method for determining an optimal classifier for classifying a target comprising preparing a training data set from a data source and a testing data set from the data source, the data source indicative of one or more features representative of a physical implementation of a target for classification, the training data set comprising a first logical data grouping from the data source and the testing data set comprising a second logical data grouping from the data source not included in the training data set, applying a classifier from a set of classifiers to the training data set to achieve a resulting distinctly trained classifier for each classifier applied, the set of classifiers selected based on the one or more features, incrementing a size of the training data set while keeping the testing data set at a fixed size and iteratively reapplying the set of classifiers to produce a resulting distinctly trained classifier for each classifier applied to a different training set size, applying each resulting trained classifier for each classifier to the testing data set and comparing a result from the application of each resulting trained classifier for each classifier to the training data set to the application of each resulting trained classifier for each classifier to the testing data set, and selecting an optimal classifier and applying the optimal classifier to the target to classify the physical implementation of the target.

The various embodiments of the present invention provide a system and method for selecting an optimal classification protocol for classifying a physical or tangible implementation of one or more targets. Each of these embodiments takes, as data input into its system and/or method, representative information of a particular target for accurate classification of the target. Various classification techniques are applied to the data to determine appropriate classifications of the target. The resulting information is used to direct optimal classification of a physical-world implementation of the target. For example, advertisements (targets) may be directed toward a person based on classification of the person's behavior, so that advertisements optimized for that person are properly directed. Similarly, newspaper articles (targets) of specific interest to a person may be directed to that person based on their preferences, interests, hobbies, work, etc. Accordingly, the present invention optimizes classification of targets so that physical-world, tangible implementations such as advertisements, newspaper articles, blog posts, websites, and any other information in which persons have an interest are optimally directed to reach the most appropriate audience.

Other features and advantages of the present invention will become more apparent from the following description of the embodiments, taken together with the accompanying several views of the drawings, which illustrate, by way of example, the principles of the invention.

### BRIEF DESCRIPTION OF THE SEVERAL VIEWS OF THE DRAWING

FIG. 1 is a flow diagram with steps in a process of deciding on an optimal classifier according to one embodiment of the present invention;

FIG. 2 is a block diagram of a system for matching a target profile with a user according to one embodiment of the present invention;

FIG. 3 is a block diagram of a system showing basic network-wide persistence according to one embodiment of the present invention; and

FIG. 4 is a block diagram of a system showing advanced network-wide persistence according to one embodiment of the present invention.

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

The present invention discloses computational methods and corresponding computer systems for associating online user survey and behavior data with one or more targets and generating algorithmically predicted behavior derived from the user survey and behavior data. A profile data set of an identified user is expanded by collection of identifiers comprising a unique anonymous identity profile permitting tracking of an individual user across multiple content sites and when accessing the web from multiple computers and locations. Efficient combinatorial generation of target attributes from template targets economizes computational resources, including processing. Computational processing functions are separated to take advantage of distributed computing with parallel processing and scalability, required to amass and effectively utilize large amounts of data per user with a large number of users, and still deliver effective target matches in real time.

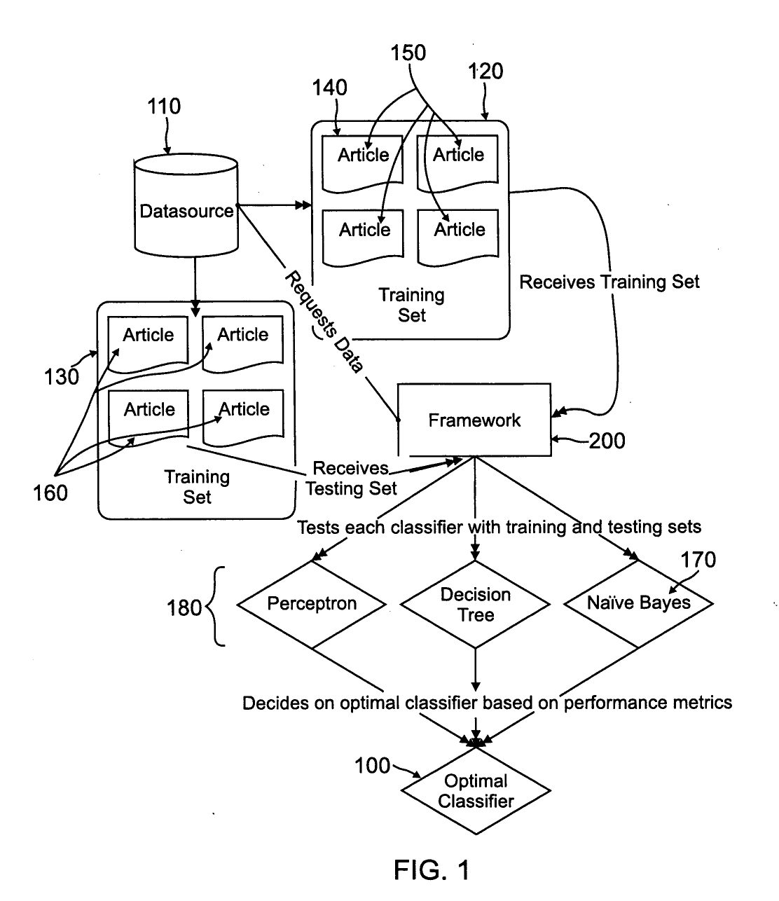

FIG. 1 is a flow diagram showing a method of deciding on an optimal classifier 100 according to one embodiment of the present invention. The present invention prepares a training data set 120 and a testing data set 130 from a data source 110. Data source 110 is data representative of target 140 indicating one or more features representative of a physical implementation of the target 140 for classification. The present invention prepares for optimal classification by identifying a first logical grouping of data 150 from the data source 110 and a second logical grouping of data 160 from the data source 110. The training data set 120 comprises the first logical grouping of data 150 and the testing data set 130 comprises the second logical grouping of data 160. The first logical grouping of data 150 and the second logical grouping of data 160 each include different data from the data source 110, so that the training data set 120 and the testing data set 130 do not include the same data.

The target 140 may be data representative of any object or subject matter which is to classified according to the methods and systems of the present invention. The present invention contemplates that any number and type of objects or subject matter may be classified, and numerous examples exist that are included within the scope of the present invention. A physical implementation of a target 140 according to the present invention may include but is not limited to physical-world items such as published articles and advertisements. Accordingly, the present invention contemplates systems and methods for classifying physical implementations of data representative of targets 140, such the data representative of targets 140 is transformed into directed classifications of physical objects such as articles and advertisements based on the principles set forth herein.

A set of classifiers 180 includes any number of classifiers 170 now known or to-be-developed. The present invention contemplates that any classifier 170 may be utilized with the present invention, and that numerous classifiers are applied to the training set of data 120 and the testing set of data to 130 determine an optimal classifier 100 for classifying a physical implementation of a target 140 according to features desired. Examples of classifiers 170 include Perceptron, Decision Tree, and Naïve Bayes. Each classifier 170 is applied to the training set of data 120 to achieve a resulting distinctly-trained classifier for each classifier 170 applied.

Classifiers 170 are iteratively applied to the training set of data 120 as a size of the of the training set of data 120 is incremented. This produces resulting distinctly trained classifiers for each classifier applied at each training set of data 120 size. Each resulting trained classifier is then applied to the testing set of data 130 and the result from the application to the testing set of data 130 is compared to the application of the classifier 170 to the training set of data 120. In this way, an iterative analysis is performed to arrive at an optimal classifier 100.

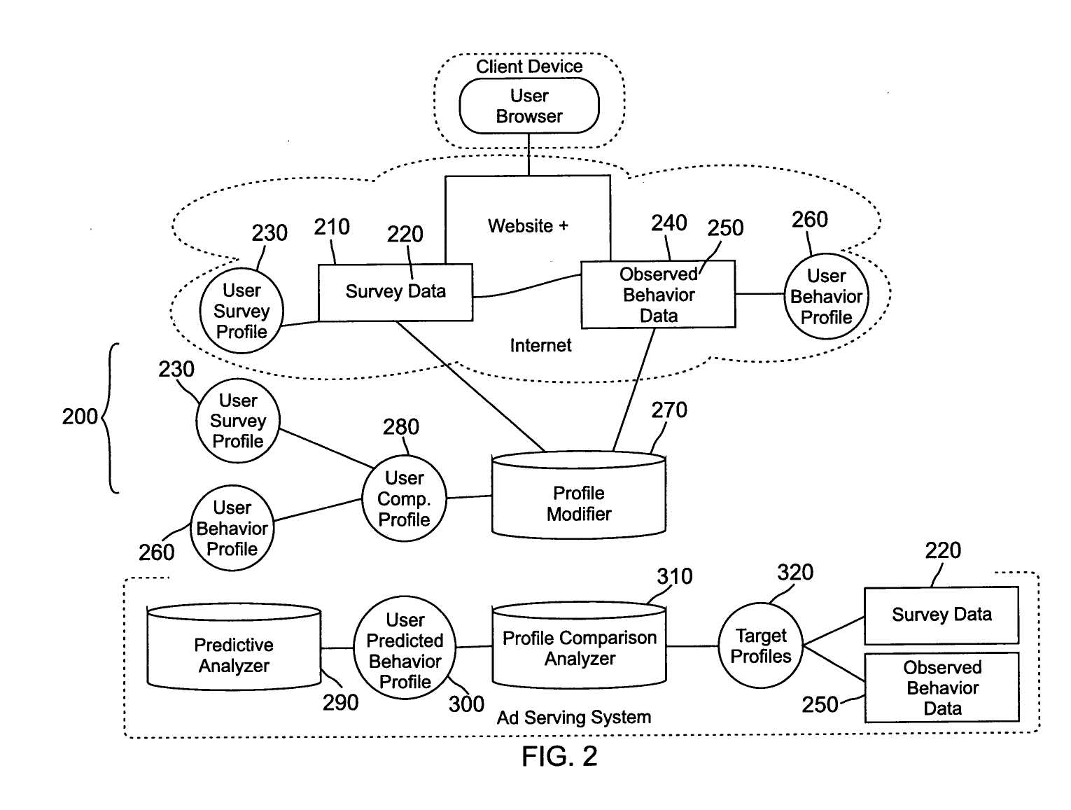

FIG. 2 is a block diagram of a system for matching a target profile with a user according to one embodiment of the present invention. The physical implementation of the target 140 is a match of targets to users, such that selection of an optimal classifier 100 results in the most appropriate classification of physical implementations of a target 140 to a user. A computer hardware environment 200 in which the present invention is implemented includes a plurality of modules. The computer hardware environment 200 includes a survey collection module 210 that collects survey data 220 from a user and assembles the survey data 220 into a collection of digital data values representing a user survey profile 230 as described herein. A behavior collection module 240 collects observed behavior data 250 from a user and assemble the observed behavior data 250 into a collection of digital data values representing a user behavior profile 260, also as described herein.

The computer hardware environment 200 also includes a profile modifier module 270 capable of modifying a collection of digital data values representing a user comprehensive profile 280 with the user survey 230 and the user behavior profile 260. A predictive analyzer module 290 analyzes the user comprehensive profile 280 to generate a user predicted behavior profile 300 comprising a collection of digital data values. Alternatively, the predictive analyzer module analyzes a profile derived from the user comprehensive profile 280. The computer hardware environment 200 further includes a profile comparison analyzer module 310 capable of comparing the user predicted behavior profile 290 to a plurality of target profiles 320 informative of the targets 140 to identify at least one target profile 320 consistent with the user predicted behavior profile 290.

For maximizing the efficiency of message targeting, greater attention must be paid to individualizing, rather than generalizing, profile data describing a particular individual an individualized in depth analysis. The ability to individualize and personalize a large number of data sets data set pertaining to an individual user and expecting to analyze each data set individually for predictive targeting purposes can become computationally resource intensive. Therefore, obtaining the substantial targeting efficiencies from a maximally individualized approach in a computationally and economically practicable manner is one object of the present invention. The efficiency of obtaining a breadth and density of information content pertaining to an individual, and the efficiency of an individualized analysis applied thereto, is an important factor in the systems and methods of the present invention.

Although generalized attribute groupings from statistical analysis of attributes is relatively easy to derive, reliably optimizing marketing decisions by distilling results from individuals statistically into a collective result is difficult. The foregoing is true because characterizing group behavior is efficient for aggregating large amounts of data, but predicting individual behavior thereby is far more difficult. Valuable information may be lost in the distillation, and in some cases the predictive value of generalizing from a curve to the individual does not justify the resources required for analysis. Thus the present invention contemplates that statistical generation or distillation of group survey data can be dispensed with in most cases where a the focus is on the individual individual-based analysis for targeting of information content.

The preceding does not mean that such analysis will never be required, but that in most cases generalized behavioral science predictive norms may be applied to individuals based upon the known characterizations in behavioral science. Thus the normative paradigm that behavior tends to be repeated can be applied to the individual analysis by accepting this rule as applicable without running the statistical analysis to establish this. For example, the conclusion that some behaviors are not repeated or are repeated periodically but with a long period of recurrence, do not require statistical vetting for application to an individual.

Interestingly, the common-sense conclusion that some behaviors, for example such as buying a new car, repeat but typically only after a substantial length of time, e.g. (that is, have a substantial period length) leads almost directly into a second paradigm of the present invention. One of ordinary skill will understand that different individuals will purchase a new car each with a different periodicity. The length of an individual's car buying periodicity might be 6 months, one year, three years or ten years, or even two weeks in some cases, but determining such with reasonable certainty by observation only, requires observation over several cycles. Thus an individual inclined to purchase a new car every four years might buy a lemon and change cars after one year before reverting to every four years and observation for five years would at best yield an estimate of about 2.5 years.

A much more simple and rapid way to obtain detailed information is to ask an individual user to affirmatively provide information online. Thus one paradigm of the present invention is that expansion over a practical time period of the data set pertaining to an individual user, the user profile, into an informationally broad and dense user profile that supports a comprehensive predictive analysis requires benefits from some type of affirmative provision of information by an individual user, as by providing answers to a questionnaire.

A corollary to the preceding is that there is a need for user-friendly, short questionnaires or surveys which allow the user to provide as much information as quickly and easily as possible. Thus the instant invention contemplates providing users a high information yield click-questionnaire or click-survey to allowing a user to conveniently and affirmatively provide information relevant to comprehensive profiling.

Reliably inferring optimum marketing decisions by distilling results from individuals statistically into a collective result is always difficult. The foregoing is true because characterizing group behavior is an efficient way to aggregate large amounts of data, but predicting individual behavior on statistical norms is far more difficult. Effectively valuable information is lost by such distillation at best. And in some cases, for example multi-modal distributions for some parameters, the predictive value of generalizing from a curve of points representing individuals may not justify the analysis.

Marketing decisions made with less than cutting edge predictive analysis information result in resources being allocated based upon decisions that were reached without the best economically practicable analysis. Consequently, resources are wasted because they are directed to statistical profiles of population groupings rather than pertaining directly to an individual user. Thus despite improvements in targeting of message content such as advertisements, most online advertisements have a click-through rate of under ten-percent, leaving room for improvement.

There is therefore a need for the present invention because more effective data mining for targeting may be obtained by increasing the breadth, information content, and density of data used in profiling an individual. The expanded data set supports an increased analytic depth of the personalized individual user based analysis. Consequently there is a need to create more expansive individual profile data sets to permit a greater depth of individual analysis.

Because the data set must be expanded to obtain a comprehensive profile amenable to an in-depth analysis, corollary needs arise for efficient and rapid data collection, and computational analysis. These corollary needs include development of cookie-less ability to both observe and obtain data cross multiple content sites and user friendly questionnaires for improved individual user profiling. Also with respect to profile data collection, user convenient and information collection facilitating a corollary need is a means of obtaining substantial amounts of data via online questionnaires that are convenient for the user and that facilitate information collection are a corollary need. And there is a need for efficient computational methods and system configurations capable of obtaining an intensive individualized analysis for a substantial and rapidly increasing number of individuals.

Thus an in-depth analysis includes expansion of the data set pertaining to an individual user. Without being bound by theory, the present invention answers this need in two ways. First the data content and density of the information pertaining to an individual is supplemented over mere observed behavior. Second, the user profile is made more comprehensive by the solicitation of user information affirmatively supplied by way of a user survey or questionnaire that is quick and inviting to a user who wants to voice her preferences efficiently.

It is important to note that a comprehensive file pertaining to an individual user is not only supplemented in information by virtue of the added user survey or questionnaire data. The value and information density of observed behavior data, including contextual observables, is augmented by being put into context and focused. This augmentation is more rapid than by merely waiting for future observation of behavior to define the context. Thus the observation that an individual has replaced a car in a year is better defined in the context of a questionnaire response indicating the normal cycle for that person is a new car every 5 years.

Indeed, with the period defined as 5 years by affirmative information supplied, observation of a recent car purchase supplies enough information to decide whether targeting a car ad is appropriate. Unless some other information pertaining to the individual is in the comprehensive profile—, for example, that the recent purchased car purchase is unsatisfactory and will therefore be replaced—, knowledge of the period as being 5 years makes targeting the individual with a car ad an inefficient use of marketing resources.

An additional consideration is that for preservation of maximum information content, user profile data must be characterized and catalogued to keep track of the source of information, including its historical perspective. Thus in various embodiments of the invention care is taken to allow reference to whether data used in predictive analysis is from observed behavior, affirmatively supplied information or a combination thereof. Also the historical context of data is preserved by the use of archived comprehensive profiles, permitting, for example, the evolution of a consumer's taste and preferences or a voter's socio-political views to be tracked, and predictive analysis to be made thereupon.

Thus the present invention is predicated upon an in-depth individualized analysis which in turn requires an aggrandized data set for the in-depth individualized analysis. The data set for profiling is expanded by obtaining affirmatively supplied information from individual users to increase the information content of the profile by both adding information and refining behavior observation data. System wide persistence permits better tracking of individual users across multiple content sites without a cookie. This permits accretion of more behavior observation data, and more opportunities for obtaining actively supplied survey or questionnaire data attributable to a uniquely, yet anonymously identified, user.

The present invention is directed to methods and systems for targeting content, for example, advertising over a network that utilizes a combination of information obtained by observing user conduct combined with actively or affirmatively submitted user information. Such actively submitted information includes, for example, responses to streamlined user-friendly user ratings of ads and/or ad features. The user facilitated questionnaire or survey employs a high information content per click based question, termed a click survey.

Evolving user specific profiles are generated by a computational utility and the profile of the user to be targeted for an online ad is provided to an ad server that matches the ad to the user who is then targeted. The method and system of the present invention supplies information to and permits input from the advertiser for the purpose of customizing ad content and a high degree of customization of the ads is envisioned. An additional feature of the various methods and systems of the invention is an anonymous unique user identification, with identity information protected by encryption or hashing, unique user identification. The collection of a set of quasi-unique, semi-unique and group identifiers over a period of observation collectively forms a unique anonymous identification profile.

The user unique anonymous identification profile allows network-wide persistence of the profile of a user without the placement of a cookie on the profiled user's computer as is described herein. The disclosed invention thus contemplates following anonymous yet uniquely identified users network-wide. The user's profile persists across a plurality of content sites that serve ads. This results in the user profile's persistence across multiple sites even if the user refuses or removes an ad-network cookie. Sites that have login capabilities may encode a unique identifier, for example, a hash, of a user's login name for the site, in the call to the ad-delivery mechanism.

The targeting system, such as for example an ad-delivery mechanism, associates the user viewing ads on a particular site with a collection of identifiers including quasi-unique, semi-unique and group identifiers. This permits the user profile information to be stored and to persist across all pages on a site or sites sending the unique identifier without placement of a cookie on the user's computer. If the ad-network-wide cookie is resident in the user's computer, it can be associated with the user unique anonymous identity profile of a given content site such that the ad ad-delivery mechanism is informed of the collection of identifiers related to a particular anonymous user, allowing a user's preferences, and observed conduct, across multiple sites and accessing the network from multiple computers to be integrated into one profile and thereby inform the targeting.

In several embodiments of the present invention additional levels of analysis may include the derivation of a profile from a user comprehensive profile 280, including simple selection of data or of a sub-profile, and employment of a predictive algorithm, including a heuristic predictive algorithm generating new data, which may update the comprehensive profile. Also, analysis of archived profiles by a trend analysis of user comprehensive profile 280, user predicted behavior profile 300, user survey profile 230, user unique identity file and any profile derived therefrom including a sub-profile of any user file. Such additional levels of analysis are performed by adding separate computational functionalities to the system to obtain efficient and scalable distributed or parallel processing configurations. Separate computational functionality may be performed by a separate processor to streamline computation for better real time performance.

Thus by way of example rather than limitation, derivation of pertinent data parameters for targeting may be by analysis of user comprehensive user profiles. All manner of information is incorporated in the user comprehensive profile, but the entire profile is not used for finding a match; rather, it is analyzed according to an algorithm that determines which information if any should be used for the match. Thus, by way of example, the profile may be culled for information relevant to the real time online contextual match, a meta-analysis comprising micro-profiling in context, or analyzed by a self learning classifier based approach.

Also, it will be understood to one of ordinary skill in the art that the method of user predictive behavior profile generation includes all manner of prediction, including a predictive method relying upon statistical normative analysis of groups having common attributes, or upon existing statistical behavioral data. Heuristic methods of profiling are also contemplated, wherein the observed results for employing or varying a profile parameter for a particular individual user informs future profiling of that particular individual user. This hyper-individualized self adjusting learning process is employed because of the inexactness of user profiling for prediction, such as in the case of predicting a response to marketing.

Another example is a system that monitors behavior at different portions of the day to develop several profiles for each user that correspond to that behavior. The method of obtaining the match is, in particular embodiments also fractalized. Employing fractalized psychographic profiling to inform targeting is another example of a heuristic predictive algorithm in which the results from the randomized targeting associations or calls are employed to learn about the individual user.

The present invention also provides, in particular embodiments, semiotic/iconic surveying and profile building. The objective is a system that is user friendly enough that a substantial proportion of the population will supplement the profiles generated by observing user conduct on the Internet (“passive” provision of information), with active input such as a quick evaluation of an ad or aspect thereof. These aspects of the invention strive to expand the individualized data set pertaining to an individual user by facilitating active user provision of data.

In particular embodiments the individualized data set is expanded by obtaining true network wide persistence. A system and method for obtaining cookie-less network wide persistence while preserving anonymity of name, username, and the like allows further expansion of the individualized data set comprising the user survey profile 230 and available for inclusion into the user comprehensive profile 280.

In certain embodiments of the present invention, highly personalized or customized targeted content is generated by a combinator. For example, advertisement content generated for the user by combining possible ad elements rather than just a match, by matching the user with an existing ad (one resident on a database). For example, the ad can be comprised of different variable elements, each variable element having a set of different possible variants, the variants chosen by reference to the user comprehensive profile 280 or a profile derived therefrom, for example a user predicted behavior file 300. Thus, a variable element may comprise one or more selectable attributes, each selectable attribute associated with a list of attribute properties from which an attribute property may be selected for a particular selectable attribute.

The individualized profiling analysis of the present invention forms an array of potential targets and associated target profiles associated with the targets. Because, for example, an advertisement may have multiple presentation formats, and many different attributes, an array of many different possibilities exist for analysis according to the present invention. Thus for a two element ad having ten choices for each element and, therefore, ten presentation formats for each element, the ten presentation formats yield 100,000 custom ads, and requires five rule based decisions. This is in practice equivalent to storing 100,000 distinct ads, but the present invention's analytical abilities saves storage space on an ad server because only the ad title and phenotype combinatorial matrix may be resident on the ad server. The advertiser would therefore maintain control of the ad content, with the ad server making a matrix coordinate call on the advertiser's server, permitting the advertiser to upgrade or modify ad elements and presentations based on data obtained from all sources. Incorporating such a rules rules-based customization approach requires less storage and the overall method and system is not obtainable by simple combination of known art.

Particular embodiments of the present invention employ a meta-analysis, a predicative analysis which is performed prior to the profile comparison-based matching process. Predictive analysis of a user comprehensive profile 280 is used to derive a profile from the user comprehensive file 280, for example by selecting data values comprising a sub-profile, and generating a user predicted behavior profile 300, that includes generating new digital data values. Any approach or core analysis may be used, including for example heuristic methods and individualized, learning based approaches.

Parallel processing is advantageously employed because the method employs a wholly separate decision on how to best match the targeted content, for example an ad, to the user based upon the existing user profile. This wholly separate decision may be performed by a separate computational functionality, which is amenable to employment of a separate processor in parallel. For example, a decision may be made as to what information is used to match with the ad: whole profile, most complete sub-profile, specific sub-profile, generalized site demographics (e.g., demographics of the user group for the site visited or enrolled in rather than of the individual user). Or, a contemporaneous context profile is generated from the entire profile and a contemporaneous context information file, and the contemporaneous context profile can be used in a computational determination of the information used to make the match. The meta-analysis saves computational time, for example, where a profile contains insufficient information to yield a meaningful match, and instead a generalized demographics-based choice should be made.

Preferred embodiments employ a meta-analytic predictive analysis comprising a meta-classification. One preferred meta-classification implements multi-dimensional learning. An array of classifiers having differing core analyses are iteratively weighted, wherein weighting adjustments or changes followed by observation permit learning and evolution of weighting coefficient sets associated with the array. Each of the plurality of classifier functions has an associated classifier function coefficient and comprises a plurality of decision nodes. Each decision node has an associated decision tolerance parameter, whereby the plurality of associated classifier coefficients collectively comprise a classifier weighting set. For each classifier function the plurality of associated decision tolerance parameters collectively comprise a decision tolerance weighting set. Each classifier function has an associated decision tolerance weighting set. The plurality of associated decision tolerance weighting sets comprises a classifier-associated array of decision tolerance weighting sets. The classifier-associated array of decision tolerance weighting sets is also iterated to obtain a progression of individual based learning at the decision tolerance level to add a second level of learning to the meta-classification-based predictive analysis.

In other embodiments random variation of the weighting factors of both data input and decision-making computations, including classifiers for making decisions in either or both levels described above. This would preferably be combined with statistical analysis of the results and learning as to the optimized weighting coefficient set for an individual user, which weighting set would evolve with the user.

The embodiments of the invention are directed to computational methods and corresponding systems for associating a user comprehensive profile 280 or a user predicted behavior profile 300 derived by analysis of the user comprehensive profile 280 with one or more targets 140. In preferred embodiments the methods and corresponding systems of the invention can track a uniquely identified anonymous user across multiple content sites or platforms and logging onto the system from multiple computers to obtain a robust and historically complete user comprehensive profile 280 by the assembly of a user unique anonymous identity profile comprising a collection of quasi-unique, semi-unique, and group identifiers which together allow a probabilistically sufficiently unique association with an un-named individual. Preferred embodiments also incorporate combinatorial and stepped combinatorial generation of target profiles 320 allowing fewer comparisons and division of processing tasks for streamlined computation.

In one embodiment the invention is directed to a computational method for associating one or more users with one or more targets 140 based on user survey data 220 and user behavior data 250. The method comprises creating a user comprehensive profile 280 for comparison with target profiles 320. Survey data 220 from a user is collected and assembled into a collection of digital data values representing a user survey profile 230. Observed behavior data of an individual user is collected and assembled into a collection of digital data values representing a user behavior profile. A collection of digital data values representing a user comprehensive profile is modified with the user survey profile 230 and the user behavior profile 260. The user comprehensive profile 280 or a profile derived from the user comprehensive profile 280 is compared to a plurality of target profiles 320. Data values from the user comprehensive profile 280 may be simply selected or a computational analysis of the user comprehensive profile 280 is performed to generate a user predicted behavior profile 300. The target profiles 320 are informative of the targets 140 permitting identification of at least one target profile 320 consistent, or parametrically close, with the user comprehensive profile 280.

Also provided is a computational method for associating user survey and user behavior data from a uniquely identified user across multiple content sites with one or more users in a computer network, for the purpose of associating the so uniquely identified user with one or more targets. The method comprises collecting a plurality of identifiers pertaining to a user accessing a plurality of different sites, an identifier comprising a collection of digital data values, whereby the collection of identifiers represents a user unique anonymous identity profile, which is maintained and updated for each particular user identified. The collected identifiers may be quasi-unique, semi-unique and group identifiers that together uniquely yet anonymously identify a particular individual user to a sufficient level of probabilistic certainty for the targeting purpose. Thus the user unique anonymous identity profile identifies an individual user substantially uniquely, and enables following an individual across a plurality of sites, permitting the user survey profile 230 and the user behavior profile 260 to be collected from the plurality of sites. A user having an associated user unique anonymous identity profile logging onto a computer connected to a computer network and engaging in one or more activities can be associated with the unique identity profile by observation of the one or more activities on the computer network.

Thus in preferred embodiments for matching a target with a profiled user, the data set for profiling is expanded by both combining observed behavior data with affirmatively, actively submitted survey data and expanding the scope of data collection by following an individual user across multiple content sites without placement of a cookie, e.g., cookie-less network-wide persistence. This network-wide persistence is obtained without cookie placement in the user computer by accumulating a collection of quasi-unique, semi-unique and group identifiers comprising a unique anonymous identity profile.

In a preferred embodiment the present invention comprises a computational method for associating user survey and user behavior data from a uniquely identified user across multiple content sites with one or more users in a computer network, and for associating a uniquely identified user with one or more targets. The method comprises collecting a plurality of identifiers pertaining to a user accessing a plurality of different sites, and an identifier comprising a collection of digital data values, whereby the collection of identifiers represents a collection of digital data values comprising a user unique anonymous identity profile.

Survey data is collected from a user and assembled into a collection of digital data values representing a user survey profile; observed behavior data of a user is collected and assembled into a collection of digital data values representing a user behavior profile. A collection of digital data values representing a user comprehensive profile is modified with the user survey and behavior profile data. The user comprehensive profile is computationally analyzed by an algorithm to generate a user predicted behavior profile. The user predicted behavior profile or a profile derived from the user predicted behavior profile is compared to a plurality of target profiles, informative of the targets, to identify at least one target profile consistent with or matching the comprehensive profile.

The unique anonymous identity profile identifies an individual user substantially uniquely across a plurality of sites, permitting the survey and behavior profile data to be collected from the various sites. A user having an associated unique anonymous identity profile logging onto a computer connected to a computer network and engaging in one or more activities can be associated with the unique identity profile by observation of the one or more activities on the computer network.

In another preferred embodiment present the invention comprises a method for associating a uniquely identified user with one or more targets, wherein the target profile comprises a defined target profile obtained by a combinatorial generation. A defined target profile is generated from a template target comprising one or more variable elements. Each variable element has at least one selectable attribute, each selectable attribute having properties that may be selected. An individual attribute property is selected from an attribute properties list, which corresponds to an individual selectable attribute. The attribute properties list comprises a plurality of entries, each of the plurality of entries specifying a property that may be selected for the individual selectable attribute to which the attribute properties list corresponds. Making the selection from the attribute properties list for each selectable attribute of each variable elements of the template target generates a defined target profile. The initial comparison of the user comprehensive profile or a profile derived therefrom with the target profiles may utilize at least one target profile comprising a defined target profile to identify at least one target profile consistent with the user comprehensive profile. Alternatively the comparing may initially be of the user comprehensive profile or a profile derived therefrom with target profiles, at least one of the target profiles comprising a template target whereby at least one matching template target consistent with the comprehensive profile is identified. The at least one matching template target is utilized in generating a plurality of defined target profiles. After generating the defined target profile the user comprehensive profile or a user profile derived therefrom to the plurality of fully defined targets.

The computational method further comprises archiving user profiles wherein user profiles of at least one user are archived at a time interval and a set of archival profiles exists comprising a most recent profile and at least a next most recent profile preceding the most recent profile by the time interval. Preferably the set of archival profiles has an oldest archival profile dating back to an earliest profile associated with the user. Archiving allows change analysis in any user profile over time, which may be performed by utilizing the set of archival profiles. Earlier profiles may precede a next most recent profile in the set of archival profiles by a first time interval or one or more additional time intervals. User profiles comprising a set of archival profiles are selected from the group consisting of user survey profile, user behavior profile, user comprehensive profile, user predicted behavior profile and user unique anonymous identity profile.

In embodiments employing an algorithm to generate a user predicted behavior profile, the generation of the user predicted behavior profile may be at least in part by selecting pertinent digital data values from the user comprehensive profile. The user comprehensive profile may be organized into sub-profiles, and the selecting pertinent digital data values from the user comprehensive file is at least in part by selecting a sub-profile, which sub-profiles are relationally organized. In some embodiments, the predictive algorithm may additionally generate new digital data values for the user predicted behavior profile, which new digital data values may supplement the user comprehensive profile. The predictive algorithm is heuristic. And in embodiments employing a heuristic predictive algorithm and archiving of profiles, the change analysis of archived user profiles may inform the heuristic algorithm.

Also provided in some embodiments for collecting survey data from a user is a high-yield click survey. The high-yield click survey is by clicking on a point in an area having two dimensions, the point having two coordinates, one in each of the two dimensions, wherein the two coordinate values signify distinct data pertaining to the user survey profile.

In preferred embodiments, the present invention is a computational method wherein computationally analyzing the user comprehensive profile includes an iterative analysis employing an array of a plurality of classifier functions. Each of the plurality of classifier functions has an associated classifier function coefficient and comprises a plurality of decision nodes. Each decision node has an associated decision tolerance parameter, whereby the plurality of associated classifier coefficients collectively comprise a classifier weighting set. For each classifier function the plurality of associated decision tolerance parameters collectively comprise a decision tolerance weighting set. Each classifier function has an associated decision tolerance weighting set. The plurality of associated decision tolerance weighting sets comprises a classifier associated array of decision tolerance weighting sets. The classifier weighting set and the classifier associated array of decision tolerance weighting sets collectively comprise a weighting coefficient matrix.

In each iteration a predicted behavior profile is generated, using the weighting coefficient matrix, and compared to a post-prediction observed behavior profile collected subsequent to generating the predicted behavior profile. The comparison informs adjustment of the weighting coefficient matrix to generate an adjusted weighting coefficient matrix comprising adjusted classifier function weighting coefficients and adjusted decision tolerance parameters. A predicted behavior profile is generated using the adjusted weighting coefficient matrix in a subsequent iteration. Following an individual user over a series of iterations allows evolution of an individually optimized weighting coefficient matrix as individual users personalized preferences are learned.

In some embodiments the classifier weighting set may be separately analyzed using a representative subset of the decision tolerance weighting sets from the classifier associated array of decision tolerance weighting sets. Following this separate analysis, only classifier functions having a sufficiently high adjusted weighting coefficient are analyzed using the complete classifier associated array of decision tolerance weighting sets.

The present invention in one embodiment is a computerized system for associating survey data and behavior data with one or more targets. The system comprises practical processing functions, including: (i) a survey collector capable of collecting survey data from a user and assembling the survey data into a collection of digital data values representing a user survey profile; (ii) a behavior collector capable of collecting observed behavior data from a user and assembling the observed behavior data into a collection of digital data values representing a user behavior profile; (iii) a profile modifier capable of modifying a collection of digital data values representing a user comprehensive profile with the user survey profile 230 and the user behavior profile; and (iv) a profile comparison analyzer capable of comparing the comprehensive user profile or a profile derived from the user comprehensive profile to a plurality of target profiles, the target profiles informative of the targets. At least one target profile consistent with the comprehensive profile may be identified as matching or parametrically close to the comprehensive profile or profile derived therefrom. The plurality of target profiles may, for example be ranked according to parametric proximity to the comprehensive profile, and at least one target profile is thereby identified as a match, for example as closest or falling within a specified distance of the target in n-dimensional space.

In a preferred embodiment, the present invention is a computerized system for associating a user predicted behavior with one or more targets. The system comprises practical processing functions. The system includes: (i) a survey collector practical processing function capable of collecting survey data from a user and assembling the survey data into a collection of digital data values representing a user survey profile; (ii) a behavior collector capable of collecting observed behavior data from a user and assembling the observed behavior data into a collection of digital data values representing a user behavior profile; (iii) a profile modifier capable of modifying a collection of digital data values representing a user comprehensive profile with the user survey profile 230 and the user behavior profile; (iv) a predictive analyzer capable of analyzing the user comprehensive profile or a profile derived from the user comprehensive profile according to and wherein user profiles of at least one user are archived at a first time interval.

Typically the computerized systems of the present invention further comprise a database comprising a mass storage device controlled by a database manager to serve as a repository of data including user comprehensive and user unique anonymous identity profiles. The database preferably comprises a relational database, more preferably an object relational database. The database permits user profile archiving according to preferred embodiments of the present invention. User profiles are archived at a given time interval. A set of archival profiles exists comprising a most recent profile and at least a next most recent profile preceding the most recent profile by the first time interval.

The computerized systems of the present invention may also further comprise a target profile combinator processing function, wherein the target profile combinator generates a template based array comprising at least one possible defined target profile from a specific template target. And for advantageous expansion of the data set pertaining to a particular individual by obtaining cookie-less network wide persistence the systems of the invention preferably incorporate an identifier collector practical processing function capable of collecting a plurality of identifiers pertaining to a user accessing a plurality of different sites, an identifier comprising a collection of digital data values, whereby the collection of identifiers represents a user unique anonymous identity profile, which identifies an individual user substantially uniquely across a plurality of sites. A user having an associated user unique anonymous identity profile logging onto a computer connected to a computer network can be associated with the user unique anonymous identity profile by observation of the one or more activities on the computer network.

One of skill in the art of targeting of information content based upon online information will apprehend that systems for practicing the methods of the instant invention, including for example online methods of art terminology based machine translation, may be constructed based upon adequate practical computer processing capacity, practical processing capacity referring to processing capacity operatively linked to random access memory (RAM), and mass storage capacity. An artisan of ordinary skill in the field will appreciate that the phrase practical processing capacity is used to refer to the operative combination of RAM and processor functional capacity for descriptive brevity and clarity rather than to impose any limitation of the instant invention. Any practical processing capacity may be employed.

A computerized system according to additional embodiments of the present invention further includes physical components such as a target profile combinator processing function. The target profile combinator generates a template based array comprising at least one possible defined target profile from a specific template target. For obtaining cookie-less network wide persistence the system may incorporate an identifier collector, another practical processing function that is capable of collecting identifiers pertaining to a user accessing one or more content sites. The identifier collector identifies an individual user substantially uniquely across a plurality of sites. A user having an associated user unique anonymous identity profile logging onto a computer connected to a computer network can be associated with the user unique anonymous identity profile by observation of the one or more activities on the computer network.

The system is tested for two preferred embodiments of the invention. Both embodiments utilize a heuristic predictive algorithm which generates data that supplements the user comprehensive profile, obtain network wide persistence by collecting data comprising a user unique anonymous identity profile, incorporate archiving of all user profiles at a 10 minute intervals, utilize a high yield click survey and combinatorial target generation. In both methods the user predicted behavior profile supplements the user comprehensive profile which is also updated by new observed behavior and survey profile data, thus informing the prediction with both computed iterative predictive modeling data and collected observed or survey ‘hard’ data. The heuristic algorithm of both methods is also informed by a trend or change analysis of the archived profiles, including archived user predicted behavior profiles. Thus the methods may be described as employing multi-level heuristic or multi-dimensional heuristic predictive algorithms. Archiving intervals of 10 minutes are chosen to compress simulated time and load the system with archiving tasks 36 times in a 6 hour cycle as might occur over a much longer period of time in actual implementations.

The combinatorial target generation differs between the two preferred embodiments tested. One uses a single step combinatorial process wherein defined target profiles are generated during a unified matching process from the template target, and compared with user predicted behavior profiles to identify one or more defined target profiles consistent with an individual user. The other uses a two step combinatorial generation in which a user predicted behavior profile is matched initially with at least one template target. A plurality of defined targets are combinatorially generated from each template and compared with the user predicted behavior profile for proximity to identify one or more consistent defined target profiles.

The simulation establishes the system capacity for implementing both methods. Capacity is much improved with stepped combinatorial target generation, and matches are determined more quickly. The stepped combinatorial approach is also observed to identify fewer defined target profiles that are within a given parametric proximity to an individual user profile. But typically the highest ranked or most proximate matches are obtained by both, with the single step method taking longer but finding more matches.

A simulation is run on the same method except with no combinatorial generation of defined templates. The simulation demonstrates performance of the non-combinatorial approach to be substantially identical to the one step combinatorial approach. And, time for identifying user associated defined targets is the same, but database resources are found to be conserved by the combinatorial approach over the non-combinatorial method, resulting in marginally higher user capacity. The two step combinatorial approach is shown to be substantially faster and has substantially higher capacity for users than both non-combinatorial and unified combinatorial approaches. Fewer matches are found with the stepped combinatorial than the unified combinatorial and the non-combinatorial approaches. But the highest ranked or parametrically most proximate set of defined target profile matches from the methods are the same for a majority of individual users, with greater deviation as the number of matches in the set increases. Thus there is identity for a vast majority of users when only the highest ranked or most proximate match is compared between the individual methods, with less substantial similarity when the highest ranked 10 defined target profiles are compared across the three methods.

### Embodiments Related to Improvements in Advertisement

### Components of Advertisement Rating System and Operation of Same

An advertisement network includes a plurality of content sites and other interactive media or content presentation layers (e.g., search engines, in-video displays) and the systems in place to serve advertisements to these content sites and presentation layers (e.g., advertising servers, databases to store ad information and user profiles, etc). Advertisements themselves may be served from centralized ad network servers, or by each individual content site. In the latter scenario, each individual content site utilizes some proprietary connection mechanism to a centralized set of ad decision servers to help make ad choices for individual users (e.g., a SOAP interface to ask the centralized ad server to pick an ad from a set of ads for a user whose profile which is stored on the central server).

The ad network attempts to identify unique users when serving ads by:
Attempting to set an ad-network-wide cookie
Failing the ability to set a cookie, the ad network attempts to identify unique users when serving ads by attempting to look up a user's profile by a unique identifier (discussed below) or a combination of semi-unique identifiers (e.g., if a user has the same real full name and IP address as an already present profile, there is an increased probability—though by no means certainty—that the user requesting advertisements is the same individual as that described by the already present profile).

A user profile constitutes the collection of information that the ad network holds about a unique individual. It includes uniquely and semi-uniquely identifying information about an individual that has been anonymized or hidden via either a hashing algorithm (e.g., SHA1/2) or encryption (public key encryption where each content site providing the information encrypts it with the ad network's public key and the ad network's private key remains private, or shared-key symmetric encryption where all content sites and the ad network share a single key). For unique identifiers, the present invention envisions a system where a content site would, when requesting advertisements to be displayed, optionally provide anonymized tokens that correspond to pre-defined key-value pairings that the ad network is aware of.

For example, a content site may send a request for advertisements that indicates that the user's real email address is ‘914fec35ce8bfa1a067581032f26b053591ee38a’ (the SHA1 hashed value of ‘example@example.com’). A content site may also provide semi-unique identifiers such as a hash of the user's full real name, or first name and last name separately, or a hash of the user's IP address. The ad network, upon receiving these key-value pairings (some unique identifier type paired with an anonymized/hashed/encrypted version of the real value of that identifier type for this particular user), will attempt to include them in an already known user profile if the user's profile may be readily identified using an ad-network-wide cookie, or if any of the unique identifiers matches an already-known unique identifier for a user profile already in the ad network system. Over the course of time, then, a user's profile should include many unique identifiers and many more semi-unique identifiers. Taken together, these identifiers can anonymously but uniquely identify a user in a variety of situations across many different types of content sites—as different subsets of content sites may only have partial information about a user, such as a single unique identifier.

A user's profile also contains numerous feature-value pairings that describe the user's preferences and actions within the ad network system. These features are described herein.

A user may also choose to access their profile on the ad network site further customizing their selection of brands, interests, and preferences. The user will be identified with login credentials, an email address and password, that will then be associated with the profile if it already exists. The ad network may also associate the login with a cookie for any pre-login ad network preferences. This operation requires an active user role in customizing advertisement preferences, but ultimately helps the ad network display more relevant ads to the consumer, and more qualified consumers to the advertiser. This option is a paradigm shift in the internet advertising arena, where the consumer is in full control of what ads are displayed, not the advertiser or some other tracking method, pattern assumptions or display algorithm.

Features that categorize a user's preferences in the ad network system may consist of anything quantifiable about the user and their recorded actions. Several examples of the types of features a user's profile may store:
Overall click-through rate
Click through rate on a subset of sites called ‘x’
Click through rate on advertisements linking to content/products with the term ‘hiking’ in them
Click through rate on advertisements shown between the hours of 6 PM and 10 PM
Number of ads served during specific times

Features are created during an analysis of user actions (real-time) or in a subsequent analysis phase. This analysis phase could result in the ad network adding a new feature to the user's profile based on the result of the presence of a set of observed features, where this new feature captures these observations in a manner that would be useful to advertisers—e.g., if a user clicks on a certain type of ad consistently, and then a non-real-time analysis discerns that the user clicks on this certain type of ad only during a certain period of the day).

The present invention contemplates that the ad network's analysis and feature measurement system is able to operate using multiple processes/threads analyzing and measuring features on the same user profile. This would enable the system to make updates and adjusted judgments faster, and is a natural consequence of feature-independence. While some features will be co-dependent on each other, many (such as the features listed above) can be measured and updated independently and are thus good candidates for parallelization.

The pool of features measured over user profiles can be chosen by analytic or heuristic methods, and does not need to include all possible features present in the ad network system at the time the analysis takes place in order to be useful. For example, it is clearly beneficial to update chiefly the features that will be affected by the user's most recent actions when these actions trigger an analysis of the user's profile. If a user clicks on an ad, the ad network system will update features in the user's profile pertaining to attributes of that advertisement and the user's current environmental factors (e.g., the present time of day, the user's IP address, etc). This update scheme ensures that updates remain rapid when it is important that they be so (such as when a user indicates a negative preference for an ad, and a new ad that is dissimilar must be immediately displayed), and also allows for complete analyses of the total available feature set whenever time allows for it (such as background processes that regularly scan all user profiles).

Features that categorize an advertisement in the ad network system may consist of anything quantifiable about the ad itself, its linked content, products, its advertiser or any association that the advertiser wishes to draw out.

In general, these will consist of advertiser-specified attributes about the advertisement (“Number of people in the graphical ad,” “Dominant colors in the ad,” prominent keywords associated with the ad and some relevance metric about them (e.g., their frequency in a body of text, etc), “Industry/ies) relevant to the ad”). However, the ad network system could also perform a number of computational analysis procedures on the ads in the system in order to ascribe new features. Consider, for example, OCR technology over any text appearing in a graphical ad, or graphical object-recognition technology over a class or type such as ‘cars’, ‘men’, ‘women’, or even something more abstract such as ‘hard edges’, ‘circles’, etc)

Advertisement features would chiefly be used in grouping ads together for selection purposes, as well as ascribing new measured features to user profiles. For example, if the ad network system measures how many women appear in an advertisement, it immediately becomes possible for a user's profile to have new features such as the ‘average number of women in advertisements clicked on’ and ‘average number of women in advertisements not clicked on’ that can both be powerful predictors.

The present invention contemplates the following advertisement delivery mechanisms:
Flash or other containerized video formats that accept a plurality of types of content;
Standard text ads delivered via an iFrame;
Standard text ads delivered via an AJAX call to update any unique page element (such as a <div>, <p>, etc);
Video or graphical ads delivered via an iFrame;
Video or graphical ads delivered via an AJAX call.

The present invention contemplates “+/−” icons as well as other possibilities, such as a star-rating system with some semiotic or semantic meaning applied to the stars (e.g., 1 star means ‘I hate it—show me something else’, 4 or 5 stars indicates strong preference and takes the user to the destination of the advertisement, etc). Further possibilities include a drag-able selector across a one-dimensional bar indicating preference, or as previously discussed, any multi-dimensional selector indicating different qualities of preference. It is evident that the user's patience with rating systems will go down as they increase in complexity, so a binary rating system is almost certainly preferable, and it is difficult to conceive of an easy-to-use rating system that goes beyond 2 dimensions of specification and could immediately be used by all viewers of ads.

In selecting an advertisement, the ad selector may have access to the user profile as well as all advertisements in the ad network system. The ad selector is also necessarily aware of the site and content delivery mechanism for which ads are being selected.

If the site or content delivery mechanism falls into a one of the ‘clusters’ that the ad network system has defined in the past, and the user has a sub-profile (partial profile/cluster-specific profile) pertaining to that cluster, then this sub-profile will have greater weight in selecting an advertisement for the user.

In selecting an ad appropriate for the user, the user's profile will be compared with a number of target profiles (these targets could correspond to multiple ads, or a single ad may even have multiple target profiles as determined by previous matchings of users to ads). A randomized weighting factor could also be built in to prevent a user from seeing only a small subset of ads if he/she does not actively interact with them over multiple page visits. Once a sufficiently-closely-matched target profile is found, the ad(s) associated with that target profile are delivered to the content site/delivery mechanism requesting the ads.

In terms of actual selection and comparison algorithms, a bayesian, SVM, or kernelized perceptron approach have all been considered. The actual method must be chosen once some empirical results have been obtained.

In one embodiment, a user's profile consists of Brands, Interests, and Trends. A Brand is simply a company which a user favors or dislikes based on a star rating. An Interest is a particular topic, be it sports, leisure, goods, politics, technology, and likewise has a “discard bin”. A Trend is a measurement of Brands and Interests over time. For example, if a user interacts with ads from wireless carriers, the network will attempt to predict the user is presently shopping for a new wireless provider. If the user has rated a carrier (Brand) in the past as favored, the network will deliver that Brand's ads first. If the user no longer interacts with ads from wireless carriers, and instead pursues digital cameras, the network attempts to predict the user is now shopping for digital cameras and will repeat the Trend calculation process by evaluating favored Brands first. Also, wireless service and digital photography are now automatically added to a user Interests.

Instances of Brand/Interest/Trend preferences may all be represented by features in the users profile. For example, a Brand feature named ‘Likes Nike’ may be represented in a user's profile with a scalar value from 0 to 1, and the user's actions on Nike ads (and perhaps ads containing brands related to Nike) will affect the value of this feature in the user's Profile. Additionally ‘Trend features’ can be discerned by meta-analysis of the user's profile (the user's interactions with certain types of ads over time, for example). In this way micro-trends (specific to a user or small cluster of users) and macro-trends (those relevant to a large population of users) may be discerned by the ad network system.

Advertisements, when uploaded into the system, may require advertisers to categorize for known demographics, and also tag the ads with metrics that describe features of the ad. For example, and ad for a Hewlett-Packard Ink Jet printer is uploaded, some advertisers may feel that more men will be responsible fore buying technology in a household, so they target men 25-55 (or whatever age range and demographics the advertiser feels best suits their product) and categorize it as belonging to “technology, computers, consumer goods, digital photography”. They tag the ad as such “color ink-jet printer, hewlett-packard, blue background, whimsy font, rebate offer, bargain”. The present invention may compare those targets, categories and tags with a user profile of Brands, Interests and Trends to calculate an appropriate ad.

Advertisements will have a rating system of with possibilities including:
Approve/dismiss. Advertisements may offer a boolean +/− or thumbs up/thumbs down rating system for approve/dismiss feedback
Scalar value. Advertisements may offer a sliding scale where a small pointer can be positioned on a (left-to-right, gradually increasing in height) bar.
Star value. Advertisements may offer a possible 5 star rating which will provide a simple intuit
Two-dimensional plotting system. A two-dimensional ad rating system (horizontal and vertical grid with plot-able “dot”) will allow users to provided maximum feedback in a single click. For example, once the user hovers over an ad, a grid appears with labels (left-to-right could be interest, bottom-to-top could be relevance)

Ad rating legends may be provided to orient the user. Once the consumer becomes familiar with a legend, they can quickly give feedback without disrupting their browsing, reading, shopping, etc.

A low rating dims/fades/hides the ad with no environmental change; middle ground ratings merely rate the ad with no graphical or environmental change, a high rating will initiate a prompt to visit the advertiser, approving environmental change. The network will not continue loading ads based on low ad rating, this results in a tedious, repetitive process until a consumer ultimately becomes side-tracked from their original visit or intention on the website (as witnessed on Facebook). The network will simply dim/fade/hide the ad and wait for another page load to calculate preferences to show a more relevant ad.

The user interacts with the ad, assigning it a rating based on his or her preferences. This rating is passed back to the ad network updating a feature set in a user Profile. A legend may be referenced to determine the user's level of interest, and the rating is compared against other ads the user has interacted with. Conditional algorithms are used to measure features of the profile (if the rating is Brand, Interest, or Trend specific) and calculates a formula to show or bypass similar ads.

Careful consideration must be taken in profiling the user and ad rating. A consumer may favor a particular Brand, or may opt to deviate from a typical Brand in favor of a product or service that better suits their Interest or is comparing Brand products to fulfill an Interest. If a consumer clicks and or rates several different Brands in a similar Interest, a Trend is created.

Trends are established dynamically and hold a finite longevity. If activity in a particular Interest is recurring, that Trend is tracked until a given timeframe expires, or perhaps the Trend is seasonal (i.e. Skiing, Mountain Biking) in which case the Trend may repeat itself in a year. If a Trend is recurring from year to year, the consumer's Interest profile is updated and weighted more heavily than non-Trend Interests.

### Embodiments Related to Advertisement Customization Based on User Profiles

As discussed above related to improvements in advertisement targeting, each user profile may include the collection of information that the ad network holds about a unique individual, including features that categorize and characterize a user's preferences, both those actively specified by the user through profile management and those determined based on the user's responses to delivered ads. The user profile so defined will be used to select appropriate ads for the user, and furthermore can be used to customize components of an advertisement according to the user's determined preferences. The present invention therefore also contemplates means of customizing components and sub-components of individual ads in accordance with the features of the profile the ad has been matched with.

An advertisement template for an advertisement in the ad network includes an optional specification provided by the advertiser that supplements the ad, allowing it to be altered to more closely match the user profile in question. This process makes the ad more likely to receive a click. Once an ad is selected for a user, an ad customizer will determine whether any information in the user profile should be used to customize areas of the chosen ad such that the ad is made more appropriate (more preferable to the user). Ad customization may consist of choosing one or more components from a larger set of components for display; adding an optional component to the ad; removing an optional component from an ad; and specifying the manner in which a component is displayed in the ad.

Examples of components of the ad template include:
any of the ad features as specified by the advertiser and disclosed above (i.e., if the user profile note the user generally prefers ads with lots of people displayed, the ad customizer would opt to add more individuals in a crowd of human figures)
literal template and layout (i.e., if the user profile notes that the user generally prefers ads with large graphical elements, the ad customizer would allot additional space to an image element and display a larger image than the default image)
color (i.e., if the user profile notes that the user has a predilection for cool colors like blue and purple, the ad customizer would specify that the background of the ad be #0000CD-“Medium Blue”)
ad copy (i.e., if the user profile notes that the user disprefers ads with more than 200 words, the ad customizer would opt to remove the “Product Details” paragraph of the ad)
element styling (i.e., if the user profile notes that the user prefers large text, the ad customizer would increase the font size of the ad copy to make the text more readable for the user)
ad type (i.e., if the user profile notes that the user prefers Flash (Flash is a trademark of Adobe) ads, the ad customizer would present the interactive, Flash version of the ad)
marketing strategy (i.e., if the user profile notes that the user disprefers ads that make direct comparisons to competing products, the ad customizer would present a comedic tagline instead of a comparative tagline)

The scope of customization in an ad template may be defined in two ways by the advertiser: the advertiser may set specific rules, dependent on the particular ad in question; and the advertiser may opt to apply general rules that do not rely on the particulars of the ad in question.

Specific rules may constitute content provided by the advertiser or particular subsets of general options, and are applied to particular advertisements as determined by the advertiser. For example, an advertiser may set up a specific rule for an ad that instructs the ad customizer to use Version A of the main graphic in the ad if the user generally prefers ads that make direct comparisons to competing products, to use Version B of the main graphic if the user generally prefers comedic ads, and to use Version C if the user's preference between the two aforementioned types of ads is undetermined.

General rules do not depend on the content of the ad in question, and do not rely on a set of options provided by the advertiser, but can be optionally implemented by the ad customizer across a wide range of ads. For example, an advertiser may opt to apply a rule that increases all text sizes when the user profile specifies that a user prefers larger text. Another general rule might instruct the ad customizer to strip ads of all ad copy marked by the advertiser as optional for users that prefer graphic ads to text-based ads.

Once the customizable components, specific rules, and general rules of an ad template are set up, the ad customizer is able to optimize ads matched with users based on the preferences specified by the user profile.

Ad customization can occur as a conceptually distinct process from ad selection, taking place after the ad selector matches a user with an ad as per the process described in Disclosures for advertisement targeting improvements. In this scenario, the ad selector matches a user with an ad based on the features of the user profile and the available content on the ad network, and then the components of the ad that can be optimized for the user in question are customized accordingly. For example, the ad selector may determine that Advertisement 1 is the best match for a given user based on the time of day, host content site, and user's recorded interest in ads for sporting equipment. The user profile may additionally note a preference for graphic, rather than text-heavy ads, in which case the optional text disclaimer in Advertisement 1 is removed by the ad customizer. Advertisement 1 is then displayed to the user as selected and customized.

Ad customization can additionally occur as a temporally and conceptually synchronous procedure with ad selection. In this scenario, during ad selection, all possible versions of the set of ads in the ad network are compared, such that the ad selector is aware of the differing customized options for each ad during the selection process. If, for example, the ad selector here finds that the default Advertisement 1 is more preferable for the user than the default Advertisement 2, but Version B of Advertisement 2, in which the ad customizer has altered several of the components of the ad, is preferable to any available customizations of Advertisement 1, then the ad selector will select Version B of Advertisement 1 for display. Notably, here the ad selector and the ad customizer work in tandem, rather than sequentially; the ad customizer can make available to the algorithmic decision process all possible versions of a given ad, rather than optimizing a particular ad for a particular user.

In either scenario, once an ad is displayed, the customized components of the ad are quantified and recorded just as whole advertisements are so as to affect user profile features. Analysis of the rate and type of user response, based on user feedback and click-through rates when ad and ad components are customized, generates new features for storing with user profiles and thereby helps to optimize future ad selections and customizations for the user. Some examples of ad-component specific features that might be in user profiles include:
The user prefers ads with large graphics after 5 PM
The user disprefers ads with large text between the hours of 9 AM and 5 PM
The user disprefers ads with colored text
The user prefers Flash-based ads

Additionally, user response to the customizable components of the ad aids in evaluating the effectiveness of ad components across subsets of users and across the ad network as a whole. For example, if user response indicates that visitors of a computer gaming website prefer the interactive Flash version of Advertisement 3 more than the general population, the Flash version of Advertisement 3 will be more heavily weighted for display than its static-graphic alternative on the gaming site. Furthermore, a new advertisement, Advertisement 4, which can be customized to be either static-graphic or Flash, will be more weighted toward the Flash version on the gaming site, since interactive Flash ad components garner positive response for the given subset of users.

In the system, an ad builder will be an option where advertisers can supply necessary marketing messages and default display ads, with open-ended display results. As described above, a users preferences may be color choice, font, imagery or a combination thereof. By supplying variable metrics in the ad builder, an ad can be displayed via the ad customizer and selector to suit the users profile features. Some limitations may occur where brands do not wish to allow customization, so this method can be overridden in the ad system as to not allow ad building.

In situations where advertisers wish to retain complete control of the end user display advertisement (solidifying a brand or particular campaign), the ad builder will allow several display ad inputs where advertisers wish to maintain control of the brand and messaging. In the ad builder, an advertiser has the option to include several ads in the same media buy that are geared towards particular demographics. For example, an advertiser may wish to promote color ink-jet printers, however one ad may be better suited to females with imagery of kids, bright colors, flowers, etc whereas a male audience may prefer to see the capabilities of the ink-jet printer displayed with sports, the outdoors, earth tones, etc.

This ad builder whether automatically generated or advertiser specified, based on user profile will allow enhanced targeted marketing and allow more efficient use of media advertising budgets. Advertisers will have a slightly higher expense creating multiple version of an ad, but the targeting and demographic-specific delivery, resulting in a more qualified audience will likely justify the expense.

Examples of functions that operate on a users ad preference profile include:
replacement of default brand ad with brand ad tailored for a demographic in which the user profile matches
display priority for user profile feature matches including preferences on brand, interests and trends
hiding or subduing of ads for a particular profile feature disinterest or similar low-ranked ad
queuing of ads for a profile trend, with brand preference as a primary qualifying metric
predictive targeting and serving of ads on a plurality of content sites during a trend
blanketing ad space with combinations of display ads and text ads based on profile features during a trend
adjustment of color scheme
adjustment of font and quantity of text

### Embodiments Related to Network-Wide Persistence

As discussed above, each user profile has the capacity to contain any number of unique identifiers and any number of semi-unique identifiers—both of these categories combined will sometimes be referred to as identifiers—that enable the ad network system to track an individual user and associate actions and preference information with that user's profile even if the user is not accepting ad network cookies on all computers or devices used to access content sites or other mediums on which ads are displayed.

The ad network system is capable of using these unique and semi-unique identifiers contained within the user's profile to associate new requests for ads and new actions received from an otherwise-anonymous user (such as an ad click or rating, etc) with an already existent user profile. This network-wide persistence enables tracking user actions to support ad selection and customization in a manner that goes beyond what is possible with a standard ad network cookie, by allowing associations of actions and preferences to ad network profiles even when ad network cookies are not present on a user's computer.

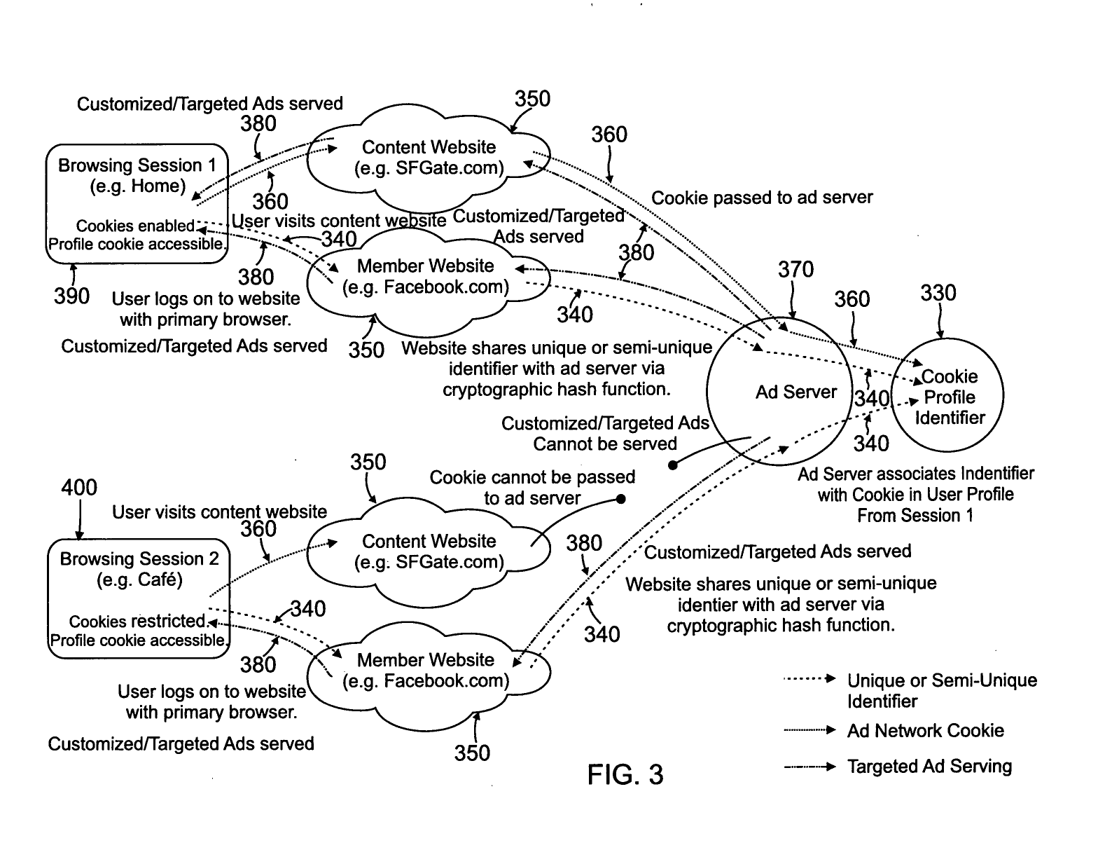

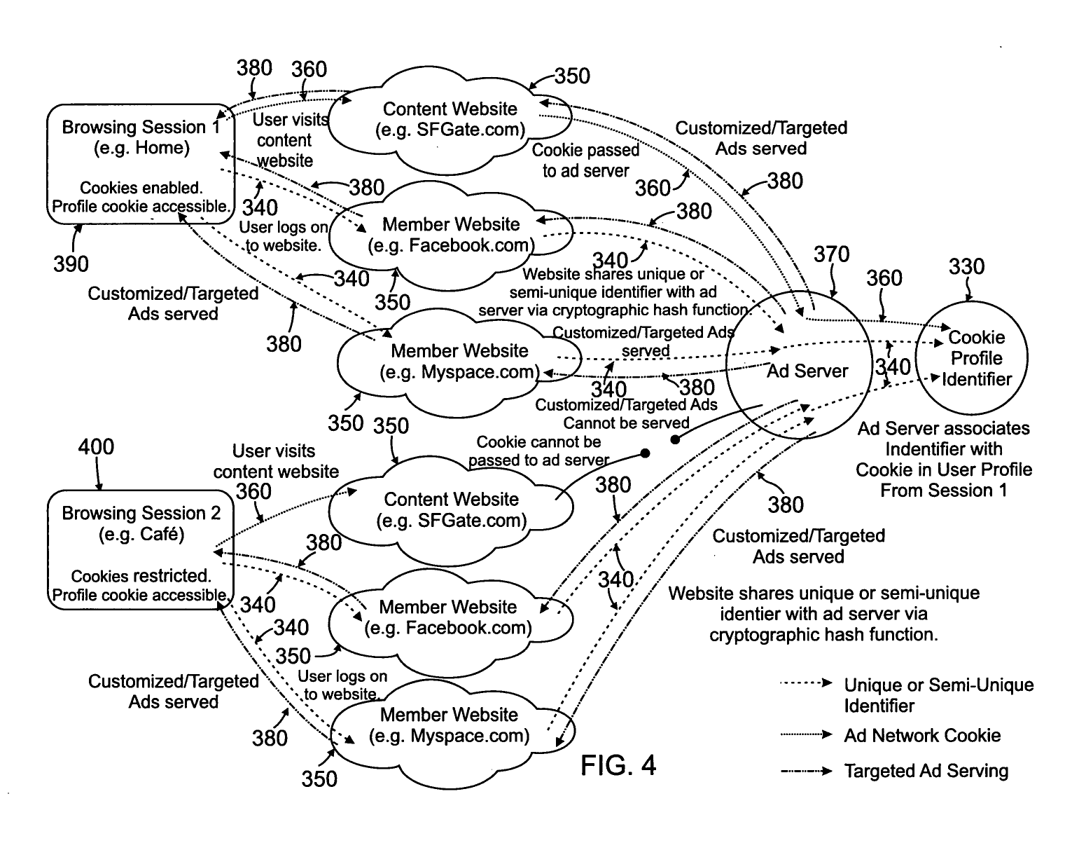

The ad network system has two modes of network-wide persistence. While both operate in a conceptually similar manner, they differ in scope and capacity. The former method, called basic network-wide persistence and graphically shown in FIG. 3, is at once more narrow and more exact, in that its capacity to identify an individual is limited to specific membership sites on which the user has previously been uniquely identified by the ad network system. The latter method, called advanced network wide persistence and shown graphically in FIG. 4, is significantly broader but relies on shared unique information among a cluster of membership sites. Both network-wide persistence methods share several common operations and data structures.

Network-wide persistence without ad network cookies is possible because the ad network system attempts to collect uniquely and semi-uniquely identifying information (identifiers) about an individual. These identifiers may include of any piece of uniquely- or semi-uniquely-identifying information about a user, such as the user's email address, id or username for a certain content site (e.g. NYTimes.com, Facebook.com, MySpace.com, etc), full real name, etc.

These identifiers may optionally (preferably) be anonymized or hidden via either a one-way cryptographic hashing algorithm (e.g., SHA1/2, MD5, etc) or encryption.

In the case of encryption, the hiding of private information can be accomplished through a public key encryption scheme wherein each content site providing the uniquely- or semi-uniquely-identifying information encrypts that information with the ad network system's public key and the ad network system's private key remains private, or shared-key symmetric encryption where all content sites and the ad network share a single key.

Hashing uniquely- or semi-uniquely-identifying information with a one-way hashing algorithm one embodiment for information sharing, because it enables the identifiers to be shared without the ad network system or any other content site being able to decode what the actual value of any identifier may be, preserving a user's privacy. In the case of public key encryption of the identifiers, the ad network system would have the capacity to decrypt the identifiers, and in the case of a single shared symmetric encryption key, all content sites would be able to decrypt the identifiers should it ever be exposed in its encrypted form. In order to best preserve the user's privacy, it is most likely preferable for content sites to use a predefined one-way hash algorithm to share all identifiers with the ad network system.

Unique and semi-unique identifiers are sent by content sites to the ad network system when a request for advertisements to display is made. This means that in whatever embodiment the ad display is being used, the medium or content site displaying the ads should also be capable of sending identifiers consisting of a ‘key’ (aka ‘name’) such as ‘email address’ or ‘Facebook account ID’ and a value, such as a hashed email address, e.g. ‘914fec35ce8bfa1a067581032f26b053591ee38a’ (the SHA1 hashed value of ‘example@example.com’). Since identifiers may also be semi-unique, the content site may send identifiers with values such as a hash of the user's full real name, or a hash of the user's IP address.

Upon receiving these key-value pairings, the ad network system stores them in the user's profile. Since the user's profile is usually also associated with any ad network system cookie placed on the user's computer, if the user travels across multiple content sites while his/her computer self-identifies to the ad network servers using the aforementioned cookie, the user's single profile will be able to aggregate identifiers from multiple content sites.

Identifiers may also be aggregated into a single unique profile even if the user does not accept an ad network cookie, if the user's profile can be uniquely identified—or probabilistically identified using a heuristic approach with an appropriate degree of accuracy—based on a combination of identifiers from content sites. For example, if multiple requests for ads are made from content sites sending identifiers indicating a certain user's Facebook id or email address, other identifiers sent by those same content sites can be appropriately stored in an ad network profile identified in part by that Facebook id or email address.

Subsequently, if a user accesses content sites from a computer which does not accept ad network cookies (for example, a public computer or a computer never before used by that user), the user's ad preferences may still be fully taken into account by the ad network system in discerning which ads to display to the user or how to customize ads, etc. The user's ad preferences can be discerned by locating the user's ad preferences profile, either through unique identifiers or, as mentioned before, a heuristic approach based on a combination of semi-unique identifiers.

Both the network wide persistence methods therefore serve as alternate methods of uniquely identifying a user seeing ads, complementary to an ad network cookie residing on the user's computer.

In “Basic” network wide persistence as shown in FIG. 3, a user's profile 330 contains unique or semi-unique identifiers 340 particular to specific content sites 350 or medium. For example, the user may have a stored unique identifier 340 from NYTimes.com indicating that their username for the site is ‘ny_example’. On the user's home computer 390 (during a first browsing session), he has an ad network cookie 360 allowing a cohesive ad preference profile to be developed across all content sites 350 the user visits. Upon the user's first visit to NYTimes.com with the ad network cookie 360 in place, the user logs in as ‘ny_example’ and some ads 380 are requested for display. This request for ads 380 also includes the unique identifier 340 indicating the user's username for NYTimes.com is ‘ny_example’ and an ad network 370 stores this information in the user's profile 330. Ad network 370 may be embodied on an ad server configured to manage operations of the ad network 370 system.

The user's profile 330 may contain a history of actions and ad preferences across a plurality of content sites 350 (e.g., Facebook.com, MySpace.com, SFGate.com, et al) while additionally containing a content-site-specific unique identifier 340 for NYTimes.com. If the user subsequently accesses NYTimes.com from a new computer 400 or during a second browsing session (one without the user's ad network cookie) or accesses NYTimes.com after clearing cookies on his own computer or disabling cookies, etc, and the user logs in as ‘ny_example’, when the content site 350 requests ads 380 to be displayed for the user it also passes the content-site-specific unique identifier 340 and thus the ad network 370 is able to show appropriate ads 380 to the user even though he does not have an ad network cookie 360 on the computer presently being used.

Actions performed and ad preferences indicated by the user while using a public computer 400 (or one without his ad network cookie) and logged in to NYTimes.com as ‘ny_example’ can likewise be stored in the user's single, unique profile 330 because the content-site-specific unique identifier 340 allows the actions and preferences to be uniquely associated with the user's general ad network profile.

Similarly, with content-site-specific semi-unique identifiers 340, a combination of semi-unique identifiers 340 sent by a specific content site 350 may be used to locate a user's profile 330 for ad display and customization 380, as well as behavior and action-tracking purposes. Content-site-specific semi-unique identifiers 340 may provide better matching than generic semi-unique identifiers 340, especially if the content site 350 has a small user population. This makes heuristic matching easier, more practical, and more accurate than generic semi-unique identifiers.

In contrast to “Basic” network wide persistence, “Advanced” network wide persistence adds the capability for a profile 330 to be located using unique and semi-unique identifiers 340 that multiple content sites 350 or mediums have access to, such as a user's email address or full name.

In practice, multiple content sites 350 frequently have access to similar sets of unique and semi-unique identifiers 340 (a user's email address, for example, is often a near-ubiquitous identifier on membership-based content sites, and many sites will have a user's full name).

In a similar manner to the process described above in “basic” network wide persistence, when a user accesses a content site 350 on a computer 400 (or second browsing session) that does not have an ad network cookie 360 or is not accepting cookies from the ad network, the content site 350 may provide some set of identifiers 340 for the user when a request for ads 380 is made. However, with “advanced” network wide persistence, this set of identifiers 340 need not be associated with a particular content site and can facilitate interactions like the following:

A user goes to Facebook.com using a computer that does not have, and does not accept ad network cookies 360. The user logs into Facebook using his username/password (or is automatically logged in from a previous session, etc), and a request for ads 380 is made. With the request for ads 380, the email address specified in the user's profile 330 is passed (hashed) as a unique identifier 340 to the ad network 370. The user then performs actions on and indicates preferences for ads 380 while using Facebook, and the ad network 370 is able to associate these actions with the user's uniquely-identifying email address to form an ad preference profile.

The user later goes to MySpace.com using a computer that does not have, and does not accept ad network cookies 360—this could yet another computer 400 or browsing session from the one used in the first example. The user logs into MySpace.com using his username/password (or is automatically logged in from a previous session, etc), and a request for ads 380 is made. With the request for ads 380, the email address specified in the user's profile 330 is passed (hashed) as a unique identifier 340 to the ad network 370. While the ad network 370 would not otherwise be able to identify the user and would have to begin forming a new ad preference profile using the user's email address and actions on MySpace.com as a basis, the user's email address specified in his MySpace.com profile is the same address used in his Facebook.com profile, and thus the (hashed/encrypted) values sent to the ad network 370 as an identifier are the same in both cases. The user on MySpace.com can therefore be identified as the same user who previously visited Facebook.com and the user's ad preference profile, and all historical actions and preferences can be used in ad selection and customization. Furthermore, any further actions taken on ads 380 on MySpace.com may be integrated into the same, unified ad preference profile as the one originally created on Facebook.com.

In the scenario above, the user visits MySpace.com after having visited Facebook.com, and on both websites the user has previously indicated a specific email address. In a slightly different scenario, the user may initially visit Facebook.com with his email address specified in his profile, enabling the ad network 370 to build up a profile containing a history of the user's actions on Facebook.com and the unique identifier 340 containing the user's email address. Then, if the user visits MySpace.com without his email address being present in any of MySpace.com's records, the ad network 370 may not be able to identify the user as the same user with the Facebook.com profile (as the email address would not be usable as an identifier for an ad request originating from MySpace.com). In this case, the user's visit to MySpace.com and request for ads 380 (absent any other information about the user or any cookies, etc) requires the ad network 370 to assume that the user was new and did not have any pre-existing ad preference profile or history in the system.

The ad network 370 then begins to build up a profile about the user's actions on MySpace.com using content-site-specific unique identifiers 340 such as the user's MySpace.com username and information gleaned from the user's click habits on ads and preference indications, among other behaviors. Then, at some point in the future, the user updates his MySpace.com profile to include his email address—the same address used in his Facebook.com profile. After the next request for ads is made while the user is visiting MySpace.com, the ad network becomes aware that the same user whose ad preference profile includes the content-site-specific unique identifier indicating the user's MySpace.com username has another ad preference profile in the ad network 370 including the user's email address. The ad network 370 may then merge these two profiles on the basis of the new unique identifiers shared by multiple profiles.

In the same way, heuristic algorithms can be used to merge profiles based on sufficient combinations of semi-unique identifiers 340. For example, if the ad network 370 reviews a profile, sees that it contains a large proportion of the same semi-unique identifiers (hashed full name values, for example, and hashed IP addresses) with values identical to those present in another profile, and the profile behaviors are similar (which can be determined by, e.g., a vector comparison of the feature values calculated in each of the profiles to establish some splitting/joining threshold), it may attempt to merge/join the profiles to provide a broader view of the user's ad preferences. This process allows a set of loosely-coupled user actions on different websites to be taken together to form a more cohesive ad preference profile for an individual.

Similarly, heuristic methods can be used to split profiles if it is the case that the profile operates as one or more distinct profiles, or if the behaviors in the profile are inconsistent and there is no reason to speculate the profile should be taken as a single user's profile except semi-unique identifiers. The methods used in choosing when to split a profile can be similar to those used in discerning sub-profiles, but the splitting/joining process has the added input of the semi-unique identifiers used to originally merge a joint profile, which enables the definition of thresholds (e.g., if the behaviors and features modeled in a profile differ by a certain application-specific threshold amount and the profile was merged based on some set of semi-unique identifiers, it is possible to define size and quality metrics over the set of semi-unique identifiers required to keep the profile from being split back into its component profiles).

It is possible, based on a review of many users' profiles 330, to gain an improved understanding of how certain sets of users will operate within the ad network 370. This gives the system greater predictive capacity. For example, the same processes used to join profiles (metrics defining sufficiently similar behaviors and feature values) can be used to:
Segment groups of users by their behaviors/measured feature values in order to make generalizations about how most users in the segment operate and what their preferences are
Allow advertisers to see how their ads are likely to be received in market segments
Make matching for users with very limited profile information potentially more accurate (by comparing the user to various existent market segments and seeing which segment(s) the user fits best)

The methods used to compare user profiles include feature comparison machine learning techniques like perceptrons, support vector machines, kernel methods, Bayesian comparisons, etc.

### User Profile/Network Persistence Example

An example of network persistence assisting in the creation and optimization of user profile data is as follows:

Joseph Kennedy typically accesses sites on the ad network from his laptop at home or his workstation at work. He does not actively manage his user profile, but does rate and click through ads as they appeal to him.

From home, he signs in to his Match.com user account as well as his Amazon.com user account. He views and clicks on ads while at his home computer using a browser that blocks all cookies. Despite the lack of cookies, the email address and name identifiers sent by Match.com and Amazon.com, in conjunction with the single IP, allow the construction of a unified user profile that includes information from his ad viewing on Match.com and Amazon.com.

Based on his actions at his home computer, the following information is associated with his ad network user profile:

| Key | Value |
|---|---|
| First name | Joe |
| (from Match.com) | |
| First name | Joseph |
| (from Amazon.com) | |
| Last name | Kennedy |
| (from Match.com | |
| and Amazon.com) | |
| IP address used | 96.232.157.172 |
| Email | kennedy.joe.1102@yahoo.com |
| (from Match.com | |
| and Amazon.com) | |
| Amazon ID (sha1) | 4759cce02031ca3602a4b7c0e6c1eb16e574387a |
| Observed features • | Prefers ads for sporting equipment |
| | Prefers the brand Nike |
| | Prefers two-tone ads |
| | Prefers ads with action photography |

At work, Joseph's browser allows cookies, but he does not sign into his user accounts at Match.com or Amazon.com. The ad network maintains a separate user profile based on Joseph's ad viewing behavior at his work computer:

| Key | Value |
|---|---|
| IP address used | 96.232.162.121 |
| Observed features | Prefers ads for sporting equipment |
| | Prefers ads for golf tournaments |
| | Disprefers ads with political messages |
| | Prefers ads with celebrity endorsements |
| | Prefers bank ads that discuss retirement plans |
| | Prefers ads with landscapes |
| | Prefers the color green |

Without more information, the two user profiles as they stand are not similar enough to unify across the ad network.

Joseph Kennedy, though, receives his Yahoo email using Microsoft Outlook while at work. He receives an invitation to an office party via the website eVite.com at his email address kennedy.joe.1102@yahoo.com. When he clicks on the link to view the invitation, eVite.com adds the following identifiers to Joseph's user profile:

| Key | Value |
|---|---|
| First name | Joe |
| Email | Email kennedy.joe.1102@yahoo.com |

With these additions to the user profile generated from his office workstation, the ad network is able to identify the two user profiles as two sub-profiles belonging to the same individual. The information in each profile, and the associated feature measurements, can therefore be unified, meaning Joseph Kennedy's user profile will more accurately reflect his ad viewing preferences, and more optimal ads can be selected and customized at home and at work.

### Embodiments Related to User Sub-Profiling

As discussed above, each user profile includes the collection of information that the ad network holds about a unique individual, including features that categorize and characterize a user's preferences, both those actively specified by the user through profile management and those determined based on the user's responses to delivered ads. The user profile so defined can additionally be segmented into sub-profiles that serve to improve ad selection and customization, both in terms of the suitability of matches made and the speed and efficiency with which the matches can be computed.

User profiles can be segmented into sub-profiles to optimize the set of relevant features visible to the ad selector and ad customizer in any given scenario. As discussed above, user profiles constitute a set of features that the ad network holds concerning a unique individual. The profile and the features associated with the profile may be used to match users with advertisements determined appropriate based on the calculated correlations between the profile features and a given advertisement. For example, the user profile for a user who regularly clicks on ads for high-end purses with brands such as Louis Vuitton and Coach might contain a feature noting the user's preference for fashion handbag ads. The user would subsequently be more likely to be matched by the ad selector with ads for other similar handbags or high-end fashion products.

As further discussed above, these profile features may consist of anything quantifiable, and are not limited to simple statements such as “Prefers Louis Vuitton handbags”. For example, analysis of user actions may yield that the likelihood that the user will respond positively to a handbag ad between the hours of 9 AM and 5 PM is 0.2 on a given scale, but the likelihood that the user will respond positively to a handbag ad after 5 PM is 0.8 on the same scale.

There is an infinity of possibilities, then, for possible features contained within a user profile, as the above example indicates. As a result, the accuracy of ad selection and the speed of computation can be improved by analyzing and segmenting user profiles into sub-profiles consisting of the set of user information and features relevant in a particular scenario or situation. In the example above, algorithmic analyses may determine that the user's noted preference for high-end purses between the hours of 9 AM and 5 PM is not sufficient to warrant placement of a new Coach ad during those hours. In that case, the user's profile in totality might consist of the following features:
Likes handbag ads after 5 PM
Likes the brand Louis Vuitton
Likes the brand Coach
Likes ads with images of recognizable models
Likes warm colors
Dislikes Flash ads

However, the features determined based on measured click-through rates and UI interactions to be maximally relevant during the scenario “9 AM to 5 PM” would consist of a subset of the features contained in the whole profile:
Likes ads with images of recognizable models
Likes warm colors
Dislikes Flash ads

Between the hours of 9 AM and 5 PM, then, only the above sub-profile is required during ad matching. This sub-profile aids both in selecting appropriate ads—the user won't be shown a surfeit of handbag ads between 9 AM and 5 PM—and in reducing the time and complexity of any algorithmic analyses done across the relevant aspects of the user profile by optimizing and minimizing the set of data that is regularly accessed.

Time of day (i.e., “9 AM to 5 PM”) is just one example of imaginable sub-profile segmentation scenarios. Additional scenarios sub-profiles may also be related to and dependent on include:
The browser agent being used
The IP address from which the user is accessing the ad network
The content site or sites being visited
The season
The day of the week
The reported weather
The speed of the internet connection or graphical hardware being used

In other words, as with profile features themselves, sub-profiles can be segmented based on any quantifiable aspect of user action and environment, making sub-profiling a useful means of increasing the likelihood that the ad selector will display an ad that is optimally appropriate for a given user.

For example, a user may access sites in the ad network primarily from two IP addresses, one representing the user's home computer, and one representing the local coffee shop's WiFi network. Though the ad selector and ad network may be unaware of the locations themselves (“home” and “coffee shop”), the user's differing preferences at each location are measured and quantified, and the ad selector may find that it is useful to split the user's profile according to the IP address being used to access the ad network.
From the “home” IP address, the user is less likely to click on any ads. Ads clicked on are more likely to be directly related to the content being accessed (i.e., an article in the LATimes.com Small Business section leads to a click-through for a Monster.com survey on job satisfaction in the tech industry, but there is no click-through for personal banking at TD Ameritrade). The user at home prefers ads that are text-heavy and direct in marketing style. Business services and technology ads are also preferred.
From the “coffee shop” IP address, the user is more likely to click on ads in general, and the preferred ads tend to be Flash or graphic based. Bright colors and limited text is preferred, and ads with interactive elements such as games and music are clicked on. The user rarely clicks on ads for technology or business services when accessing the ad network from the coffee shop, and the user often clicks on ads that involve geo-specific information (i.e., ads for local restaurants and upcoming concerts).

Given the distinct and measurable behavioral patterns that emerge for the user at the two different IP addresses, the ad selector may opt to divide the user profile into sub-profiles dependent upon IP address. If the “home” address is used, the user is shown ads that appeal to his interest in technology, business services, and focused content. If the “coffee shop” address is used, the user is shown ads that appeal to his graphical tastes and interests in local events and entertainment. In this way, the user experience and the efficacy of ad selection is aided by segmentation of the user profile into sub-profiles.

Notably, if a third, previously unseen IP address is used to access the ad network, the ad selector need not rely on one of the two profiles; in the case where the defined sub-profiling scenarios don't apply, the whole profile can be accessed and assessed to find the most appropriate ads given profile features other than IP address, such as general preferences, time of day, content site, and so on.

Another useful sub-profiling scenario is segmentation based on content sites or content site clusters. In such a scenario, a user's preferences are found to differ based on the content site being visited. The user profile can then be divided such that the ad displayed is optimized based on the recorded user features that pertain specifically to the content site being accessed, or to content sites determined to form a content site cluster with the site being accessed. Content site clusters are generated on a cross-user basis according to network-wide observations of content served and interested population, and also on a per-user bases according to observed user behavior.

For example, a user generally prefers graphic ads when browsing the internet, updating his profile on Facebook.com, shopping on Amazon.com, and so on. However, he is found to greatly prefer interactive Flash ads with a game-playing component when visiting the videogame console site Playstation.com. The user's profile will therefore be usefully segmented based on the content site being visited; if the user is visiting Amazon.com, graphic ads are weighted more heavily, but if the user is visiting Playstation.com, Flash ads are weighted much more heavily.

Based on network-wide observations, Playstation.com forms a content site cluster with other gaming system content sites such as Nintendo.com and VideoGamer.com. Thus, when the user visits XBox.com for the first time, the user's general preference for graphic ads is superseded by his Playstation.com sub-profile's recorded preference for interactive Flash ads, and the user is correctly matched with a Flash gaming ad. In other words, the content site cluster containing both Playstation.com and Xbox.com was used to segment the user's profile to present the user with the most relevant ad based on his sub-profile.

Sub-profiles can likewise be relevant in a user-specific content site cluster. For example, if the user above is found to prefer Flash ads on the movie-rental content site Netflix.com, the user profile data garnered from the user's actions while visiting Netflix.com can be included in the gaming sub-profile. When the user behaves according to his sub-profile in new scenarios, the sub-profile serves both to optimize the user's experience in the new scenario, and to contain the information gathered from the new scenario such that the user's experience is optimized in all situations.

It is to be understood that other embodiments may be utilized and structural and functional changes me be made without departing from the scope of the present invention. The foregoing descriptions of the embodiments of the invention have been presented for the purposes of illustration and description. It is not intended to be exhaustive or to limit the invention to the precise forms disclosed. Accordingly, many modifications and variations are possible in light of the above teachings. For example, a target may be any physical article suitable for classification to direct specific, narrowly-tailored items toward the target. It is therefore intended that the scope of the invention not be limited by this detailed description.

1. A method of determining an optimal classifier, comprising:
preparing a training data set from a data source and a testing data set from the data source, the data source indicative of one or more features representative of a physical implementation of a target for classification, the training data set comprising a first logical data grouping from the data source and the testing data set comprising a second logical data grouping from the data source not included in the training data set;
applying a classifier from a set of classifiers to the training data set to achieve a resulting distinctly trained classifier for each classifier applied, the set of classifiers selected based on the one or more features;
incrementing a size of the training data set while keeping the testing data set at a fixed size and iteratively reapplying the set of classifiers to produce a resulting distinctly trained classifier for each classifier applied to a different training set size;
applying each resulting trained classifier for each classifier to the testing data set and comparing a result from the application of each resulting trained classifier for each classifier to the training data set to the application of each resulting trained classifier for each classifier to the testing data set; and
selecting an optimal classifier and applying the optimal classifier to classify the physical implementation of the target.

2. The method of claim 1, wherein the data source is a feature profile.

3. The method of claim 2, wherein the feature profile is data relating to the one or more features, the one or more features being relevant to the classification of the physical implementation of the target.

4. The method of claim 3, further comprising selecting the one or more features based on user preferences relevant to the classification of the physical implementation of the target.

5. The method of claim 4, wherein each of the first logical grouping of data and second logical grouping of data are selected from the user preferences relevant to the classification of the physical implementation of the target.

6. The method of claim 5, further comprising determining at least one set of user preferences for the classification of the target, the at least one set of user preferences determined by analyzing each feature relevant to the classification of the target.

7. The method of claim 6, further comprising generating the feature profile based on predicted outcomes of the classification of the physical implementation of the target in which each feature in the one or more features is represented.

8. The method of claim 7, further comprising selecting a target from a set of targets.

9. The method of claim 8, wherein each target in the set of targets is representative of a physical article to be classified.

10. The method of claim 3, wherein each feature in the one or more features is assigned a weight for the classification of the physical implementation of the target.

11. The method of claim 10, wherein the feature profile includes a decision tolerance weighting set comprised of weights assigned to the one or more features.

12. The method of claim 11, further comprising labeling the training data set with one or more classes, the one or more classes representing a category of a target to classified and identifying a starting point for applying each classifier from the set of classifiers to the training data set.

13. The method of claim 12, further comprising labeling the testing data set with the one or more classes.

14. The method of claim 13, wherein the one or more classes representing a category of a target are indicative of user preferences.

15. The method of claim 14, further comprising obtaining performance metrics about each application of a classifier to the training data set.

16. The method of claim 15, further comprising obtaining performance metrics about each application of a resulting trained classifier to the testing data set.

17. The method of claim 16, wherein each class is encoded with a data representation model.

18. The method of claim 17, wherein the data representation model is a vector of measurements representing the one or more features.

19. The method of claim 18, wherein the applying a classifier from a set of classifiers to the training data set to achieve a resulting trained classifier for each classifier further comprises taking measurements across the components of the training data set using each classifier in the set of classifiers.

20. The method of claim 19, wherein the applying a classifier from a set of classifiers to the training data set to achieve a resulting trained classifier for each classifier further comprises composing an optimal set of parameters where each class in the or more classes corresponds to a most likely set of feature values.

21. The method of claim 20, wherein the applying each resulting trained classifier for each classifier to the testing data set further comprises assigning one or more categories to the components in the testing data set.

22. The method of claim 1, wherein the incrementing a size of the training data set includes determining a specified amount by which the size of the training data set will be incremented.

23. The method of claim 22, wherein the specified amount is determined by measuring an error rate derived from the decision tolerance weighting set.

24. The method of claim 1, further comprising determining an optimal size of a training data set for each classifier in the set of classifiers.

25. The method of claim 24, wherein the optimal size of each training data set differs according to a type of classifier applied to the training data set.

26. The method of claim 25, wherein the determining an optimal size of a training data set for each classifier in the set of classifiers further comprises testing differing sizes of training data sets and comparing a performance of each resulting distinctly trained classifier for each different size of training set data.

27. A method of selecting an optimal classifier type for a target in a given classification problem, comprising:
selecting a target from a set of targets, each target in the set of targets representative of a physical article to be classified and being representative of a feature profile identifying one or more features relevant to a classification of each target in the set of targets;
selecting one or more classifiers for application to a selected target;
comparing, for each of the one or more classifiers, the feature profile of a selected target to a comprehensive user data profile, the comprehensive user data profile including a user's expressed preference and a user's behavioral history;
comparing a result for each of the one or more classifiers to a predicted user data profile; and
selecting a most appropriate classifier for the one or more classifiers.

28. The method of claim 27, wherein the feature profile includes a decision tolerance weighting set comprised of weights assigned to the one or more features.

29. The method of claim 28, further comprising generating the feature profile based on predicted outcomes of the classification of the physical implementation of the target in which each feature in the one or more features is represented.

30. The method of claim 29, wherein each target in the set of targets is representative of a physical article to be classified.

31. The method of claim 30, wherein the set of targets is a set of documents.

32. The method of claim 30, wherein the user's expressed preference is generated by analyzing a user's response to a query.

33. The method of claim 32, wherein the user's behavioral history is data generated by analyzing a user's previous activity relative to the set of targets.

34. The method of claim 33, wherein the predicted user data profile is data generated by predicting user behavior for each feature in the set of features.

35. A system for associating predicted behavior with one or more targets, comprising:
a plurality of modules embodied on one or more components in a computer hardware environment, the plurality of modules including
a survey collection module configured to collect survey data from a user and assemble the survey data into a collection of digital data values representing a user survey profile;
a behavior collection module capable of collecting observed behavior data from a user and assembling the observed behavior data into a collection of digital data values representing a user behavior profile;
a profile modifier module capable of modifying a collection of digital data values representing a user comprehensive profile with the user survey profile and the user behavior profile;
a predictive analyzer module capable of analyzing the user comprehensive profile or a profile derived from the user comprehensive profile to generate a user predicted behavior profile comprising a collection of digital data values; and
a profile comparison analyzer module capable of comparing the user predicted behavior profile to a plurality of target profiles informative of the targets to identify at least one target profile consistent with the user predicted behavior profile.

36. The system of claim 35, further comprising a set of archived profiles, each archived profile including a most recent profile and at least a next most recent profile preceding the most recent profile by the first time interval, wherein the set of archived profiles has an oldest archived profile dating back to an earliest profile associated with the user.

37. The system of claim 36, wherein an analysis of change over time for a user profile is performed by utilizing the set of archived profiles.

38. The system of claim 37, wherein the user profile is selected from a group consisting of a user survey profile, a user behavior profile, a user comprehensive file and a user predicted behavior profile.

39. The system of claim 38, wherein the user predicted behavior profile is generated at least in part by selecting pertinent digital data values from the user comprehensive profile.

40. The system of claim 39, wherein said user comprehensive profile is organized into a plurality of sub-profiles, and said selecting pertinent digital data values from said user comprehensive file is at least in part by selecting a sub-profile.

41. The system of claim 40, wherein the plurality sub-profiles are relationally organized.

42. The system of claim 41, wherein new digital data values are generated for the user predicted behavior profile.

43. The system of claim 42, wherein at least one target profile in the plurality of target profiles is defined by a combinatorial selection process during which at least one target template is provided, each of the at least one target template having at least one variable element, each of the at least one variable element having at least one selectable attribute associated with an attribute properties list comprising a plurality of entries specifying a property selection.

44. The system of claim 43, wherein selecting an entry from the attribute properties list for each of the at least one selectable attribute of each of the one or more variable elements of the template target generates a defined target profile.

45. The system of claim 42, further comprising a target profile combinator module, wherein a defined target profile is generated from the target template comprising at least one variable element, wherein each of the at least one variable element has at least one selectable attribute, each of the at least one selectable attribute has properties selectable from an attribute properties list corresponding to an individual selectable attribute.

46. The system of claim 45, wherein the attribute properties list comprises a plurality of entries, each of the plurality of entries specifying a property for the individual selectable attribute, wherein selecting an entry from the attribute properties list for each of the at least one selectable attributes of each of the at least one variable element of the target template generates a defined target profile.

47. The system of claim 46, wherein the target profile combinator module generates a template based array comprising at least one possible defined target profile from a specific target template.

48. The system of claim 42, wherein the profile comparison analyzer module compares the user comprehensive profile with the target profiles, at least one of the target profiles comprising a defined target profile, and wherein at least one target profile consistent with the user comprehensive profile is identified.

49. The system of claim 48, wherein the profile comparison analyzer module compares the comprehensive profile or a profile derived from the user comprehensive profile with the target profiles, at least one of the target profiles comprising a template target, and wherein at least one matching template target consistent with the comprehensive profile is identified.

50. The system of claim 49, wherein the profile comparison analyzer module compares the user comprehensive profile or a profile derived from the user comprehensive profile to the at least one defined target profiles comprising the template based array to identify at least one defined target profile consistent with the comprehensive profile.

51. The system of claim 50, wherein a user profile of at least one user is archived on a mass storage device at a first time interval.

52. The system of claim 51, wherein the mass storage device comprises a relational database.

53. The system of claim 52, wherein the relational database comprises an object relational database.

54. The system of claim 53, wherein the mass storage device is controlled by a database manager.

55. A method for associating a uniquely identified user with one or more targets across multiple content sites, comprising:
collecting a plurality of identifiers each comprising a collection of digital data values and pertaining to a user accessing a plurality of different sites on a computer network, the plurality of identifiers representing a user unique anonymous identity profile;
collecting survey data from the user and assembling the survey data into a collection of digital data values representing a user survey profile;
collecting observed behavior data of the user and assembling the observed behavior data into a collection of digital data values representing a user behavior profile;
modifying a collection of digital data values representing a user comprehensive profile with the user survey profile and the user behavior profile; and
comparing the user predicted behavior profile to a plurality of target profiles informative of the one or more targets to identify at least one target profile consistent with the user predicted behavior profile, wherein the user unique anonymous identity profile identifies an individual user substantially uniquely across the plurality of sites, permitting the user survey profile and the user behavior profile to be collected from the plurality of sites when the user having an associated user unique anonymous identity profile accesses the computer network and engages in one or more activities associated with the associated user unique anonymous identity profile.

56. The method of claim 55, wherein the one or more targets are news articles.

57. The method of claim 56, further comprising archiving user profiles into a set of archived used profiles so that user profiles of at least one user are archived at a first time interval.

58. The method of claim 57, wherein the archiving user profiles into a set of archived user profiles includes archiving a most recent profile and at least a next most recent profile preceding the most recent profile by the first time interval, the set of archived user profiles having an oldest archived profile dating back to an earliest profile associated with the user.

59. The method of claim 58, further comprising performing an analysis of change over time for a user profile by utilizing the set of archived user profiles.

60. The method of claim 59, wherein the user profiles are selected from a group consisting of a user survey profile, a user behavior profile, a user comprehensive profile, a user predicted behavior profile and a user unique anonymous identity profile.

61. The method of claim 60, wherein at least one target profile in the set of target profiles are defined by a combinatorial selection process, wherein at least one target template is provided, each of the at least one target template having at least one variable element, each of the at least one variable element having at least one selectable attribute associated with an attribute properties list comprising a plurality of entries specifying a property selection.

62. The method of claim 61, further comprising selecting an entry from the attribute properties list for each of the at least one selectable attribute of each of the at least one variable element of the template target generates a defined target profile.

63. The method of claim 60, further comprising generating a defined target profile, wherein a defined target profile is generated for a template target comprising at least one variable element; wherein each of the at least one variable element has at least one selectable attribute, each of the at least one selectable attribute having properties selectable from an attribute properties list corresponding to an individual selectable attribute.

64. The method of claim 63, wherein the attribute properties list comprises a plurality of entries, each of the plurality of entries specifying a property for the individual selectable attribute.

65. The method of claim 64, further comprising selecting an entry from the attribute properties list for each of the at least one selectable attribute of each of the at least one variable element of the template target generates a defined target profile.

66. The method of claim 65, further comprising generating a template based array comprising at least one possible defined target profile from a specific template target.

67. The method of claim 60, wherein the comparing the user predicted behavior profile to a plurality of target profiles initially compares the user comprehensive profile or a profile derived from the user comprehensive profile with the target profiles, at least one of the target profiles comprising a template target so that at least one matching template target consistent with the comprehensive profile is identified.

68. The method of claim 67, wherein the at least one matching template target is utilized in generating at least one defined target profile.

69. The method of claim 68, further comparing the user comprehensive profile or a user profile derived from the user comprehensive profile to the plurality of fully defined target profiles to identify at least one defined target profile consistent with the comprehensive profile.

70. The method of claim 55, wherein each of the plurality of identifiers is selected from the group consisting of quasi-unique identifiers, semi-unique identifiers and group identifiers.

71. The method of claim 70, wherein the user predicted behavior profile is generated at least in part by selecting pertinent digital data values from the user comprehensive profile.

72. The method of claim 71, further comprising organizing the user comprehensive profile into a plurality of sub-profiles, and the selecting pertinent digital data values from the user comprehensive file is at least in part by selecting a sub-profile.

73. The method of claim 72, wherein the sub-profiles are relationally organized.

74. The method of claim 73, wherein new digital data values are generated for the user predicted behavior profile.

75. An article of manufacture including a computer usable medium having a computer readable program code embodied therein, the computer readable program code adapted to be executed to implement a method for determining an optimal classifier for classifying a target comprising:
preparing a training data set from a data source and a testing data set from the data source, the data source indicative of one or more features representative of a physical implementation of a target for classification, the training data set comprising a first logical data grouping from the data source and the testing data set comprising a second logical data grouping from the data source not included in the training data set;
applying a classifier from a set of classifiers to the training data set to achieve a resulting distinctly trained classifier for each classifier applied, the set of classifiers selected based on the one or more features;
incrementing a size of the training data set while keeping the testing data set at a fixed size and iteratively reapplying the set of classifiers to produce a resulting distinctly trained classifier for each classifier applied to a different training set size;
applying each resulting trained classifier for each classifier to the testing data set and comparing a result from the application of each resulting trained classifier for each classifier to the training data set to the application of each resulting trained classifier for each classifier to the testing data set; and
selecting an optimal classifier and applying the optimal classifier to the target to classify the physical implementation of the target.

76. The article of manufacture of claim 75, wherein the data source is a feature profile.

77. The article of manufacture of claim 76, wherein the feature profile is data relating to the one or more features, the one or more features being relevant to the classification of the physical implementation of the target.

78. The article of manufacture of claim 77, further comprising selecting the one or more features based on user preferences relevant to the classification of the physical implementation of the target.

79. The article of manufacture of claim 78, wherein each of the first logical grouping of data and second logical grouping of data are selected from the user preferences relevant to the classification of the physical implementation of the target.

80. The article of manufacture of claim 79, further comprising determining at least one set of user preferences for the classification of the target, the at least one set of user preferences determined by analyzing each feature relevant to the classification of the target.

81. The article of manufacture of claim 80, further comprising generating the feature profile based on predicted outcomes of the classification of the physical implementation of the target in which each feature in the one or more features is represented.

82. The article of manufacture of claim 81, further comprising selecting a target from a set of targets.

83. The article of manufacture of claim 82, wherein each target in the set of targets is representative of a physical article to be classified.

84. The article of manufacture 85, wherein each feature in the one or more features is assigned a weight based on the user preferences for the classification of the physical implementation of the target.

85. The article of manufacture of claim 84, wherein the feature profile includes a decision tolerance weighting set comprised of weights assigned to the one or more features.

86. The article of manufacture of claim 85, further comprising labeling the training data set with one or more classes, the one or more classes representing a category of a target to classified and identifying a starting point for applying each classifier from the set of classifiers to the training data set.

87. The article of manufacture of claim 86, further comprising labeling the testing data set with the one or more classes.

88. The article of claim 87, wherein the one or more classes representing a category of a target are indicative of user preferences.

89. The article of manufacture of claim 88, further comprising obtaining performance metrics about each application of a classifier to the training data set.

90. The article of manufacture of claim 89, further comprising obtaining performance metrics about each application of a resulting trained classifier to the testing data set.

91. The article of manufacture of claim 90, wherein each class is encoded with a data representation model.

92. The article of manufacture of claim 91, wherein the data representation model is a vector of measurements representing the one or more features.

93. The article of manufacture of claim 92, wherein the applying a classifier from a set of classifiers to the training data set to achieve a resulting trained classifier for each classifier further comprises taking measurements across the components of the training data set using each classifier in the set of classifiers.

94. The article of manufacture of claim 93, wherein the applying a classifier from a set of classifiers to the training data set to achieve a resulting trained classifier for each classifier further comprises composing an optimal set of parameters where each class in the or more classes corresponds to a most likely set of feature values.

95. The article of manufacture of claim 94, wherein the applying each resulting trained classifier for each classifier to the testing data set further comprises assigning one or more categories to the components in the testing data set.

96. The article of manufacture of claim 95, wherein the incrementing a size of the training data set includes determining a specified amount by which the size of the training data set will be incremented.

97. The article of manufacture of claim 96, wherein the specified amount is determined by measuring an error rate derived from the decision tolerance weighting set.

98. The article of manufacture of claim 75, further comprising determining an optimal size of a training data set for each classifier in the set of classifiers.

99. The article of manufacture of claim 98, wherein the optimal size of each training data set differs according to a type of classifier applied to the training data set.

100. The article of manufacture of claim 99, wherein the determining an optimal size of a training data set for each classifier in the set of classifiers further comprises testing differing sizes of training data sets and comparing a performance of each resulting distinctly trained classifier for each different size of training set data.
